(19) United States
(12) Patent Application Publication
(10) Pub. No.: US 2022/0191401 A1
(43) Pub. Date: Jun. 16, 2022

(54) IMAGE PROCESSING DEVICE, IMAGE PROCESSING METHOD, PROGRAM, AND IMAGING DEVICE

(71) Applicant: SONY GROUP CORPORATION, TOKYO (JP)

(72) Inventors: YUKI ASUKABE, TOKYO (JP); TAKAHIRO KOSUGI, TOKYO (JP)

(21) Appl. No.: 17/439,752

(22) PCT Filed: Jan. 23, 2020
(86) PCT No.: PCT/JP2020/002346

§ 371 Date: Sep. 15, 2021

(30) Foreign Application Priority Data
Mar. 27, 2019 (JP) 2019-060387

(51) Int. Cl. H04N 5/232; G06V 40/16; G06V 40/18; G06V 10/22

(52) U.S. Cl. CPC H04N 5/232122; H04N 5/23219; H04N 5/232945; G06V 10/235; G06V 40/16; G06V 40/18; H04N 5/232933

(57) ABSTRACT

In order to perform imaging operation control in which a defocus amount and a depth of field in any certain region of a captured image are taken into consideration, a map data generation unit configured to generate defocus map data which is calculated from phase difference information detected by a phase difference detection unit and indicates defocus amounts at a plurality of positions of a captured image by an imaging element unit; and an operation control unit configured to perform imaging operation control using the defocus map data generated by the map data generation unit are included.

### TECHNICAL FIELD

The present technology relates to an image processing device, an image processing method, a program, and an imaging device, and more particularly to a technology for imaging a subject.

### BACKGROUND ART

There are technologies for autofocus in which a focus lens is automatically focused on any certain point position in a captured image and technologies for F value control in which an amount of light of an imaging surface is automatically controlled to an optimum value.

The following PTL 1 discloses an imaging device that displays information regarding a defocus amount at the point position when a focus lens is focused on any certain point position.

### CITATION LIST

### Patent Literature

### PTL 1

JP 2016-197231 A

### SUMMARY

### Technical Problem

In the related art, since an amount of information regarding a defocus amount which can be acquired from an image sensor is small, automatic focus control for focusing and automatic F value control for optimizing an amount of light are performed on the defocus amount of any certain point position.

Therefore, when there is information regarding any certain region of a captured image, control for focusing on a certain point position in the region is performed. However, focus control in which a surface of the region is ascertained and a defocus amount at each position is taken into consideration has not been performed.

For an F value, automatic control is performed based on an amount of light in an image sensor at the point position, and thus F value control in which a surface of the region is ascertained and a depth of field at each position is taken into consideration has not been performed.

Accordingly, an objective of the preset technology is to perform imaging operation control in which a defocus amount and a depth of field in any certain region of a captured image are taken into consideration.

### Solution to Problem

According to an aspect of the present technology, an image processing device includes: a map data generation unit configured to generate defocus map data which is calculated from phase difference information detected by a phase difference detection unit and indicates defocus amounts at a plurality of positions of a captured image by an imaging element unit; and an operation control unit configured to perform imaging operation control using the defocus map data generated by the map data generation unit.

Thus, the imaging operation control is performed based on defocus amount information at a plurality of positions of the captured image.

In the image processing device according to the present technology, the phase difference detection unit detects the phase difference information with an image surface phase difference pixel in the imaging element unit.

Thus, the defocus amount is calculated using the phase difference information detected by the image surface phase difference pixel in the imaging element unit.

It is conceivable that the image processing device according to the present technology further includes a display control unit configured to generate a defocus map image indicating a distribution of defocus amounts in the captured image using the defocus map data generated by the map data generation unit and perform display control.

Thus, the distribution of the defocus amounts at the plurality of positions of the captured image is displayed as the defocus map image.

It is conceivable that the image processing device according to the present technology further includes a target region setting unit configured to set a target region in accordance with captured image content, and the target region setting unit sets a region in a captured image designated through a user operation as the target region.

Thus, the defocus map image is displayed in the target region in accordance with the captured image content.

It is conceivable that the image processing device according to the present technology further includes a target region setting unit configured to set a target region in accordance with captured image content, and the map data generation unit generates the defocus map data at a plurality of positions in the target region. Thus, data of each of the defocus amounts at the plurality of positions in the target region is calculated.

In the image processing device according to the present technology, it is conceivable that the operation control unit performs imaging operation control using the defocus map data in the target region generated by the map data generation unit.

Thus, the imaging operation control is performed based on the defocus amount information at the plurality of positions in the target region.

In the image processing device according to the present technology, it is conceivable that the operation control unit performs imaging operation control such that a defocus amount of the target region is a preset fixed value with reference to the defocus map data.

For example, in the imaging device, the operation control of the focus lens or the operation control of the diaphragm mechanism is performed so that the defocus amounts at the plurality of positions in the target region are preset fixed values.

In the image processing device according to the present technology, it is conceivable that the operation control unit performs imaging operation control such that the defocus amount of the target region is a fixed value set through a user operation with reference to the defocus map data.

For example, in the imaging device, the operation control of the focus lens or the operation control of the diaphragm mechanism is performed so that the defocus amounts at the plurality of positions in the target region are fixed values set through the user operation.

In the image processing device according to the present technology, it is conceivable that the operation control unit performs imaging operation control using the defocus map data in accordance with attribute information of the target region.

Thus, the defocus amounts at the plurality of positions in the target region are corrected in accordance with the attribute information.

The attribute information mentioned here is assumed to be various kinds of information such as information regarding attributes associated with the target region itself, such as an area of the target region, a ratio of the captured image occupied by the target region, and a position of the target region in the captured image; and attributes associated with the subject in the target region, such as the position of the subject, the number of people, an age, a gender, and a size of a face region.

In the image processing device according to the present technology, it is conceivable that the attribute information is an attribute associated with the target region. Thus, for example, the imaging operation control is performed in accordance with the area of the target region, the ratio of the captured image occupied by the target region, the position of the target region in the captured image, or the like.

In the image processing device according to the present technology, it is conceivable that the attribute information is an attribute associated with a subject in the target region.

Thus, for example, the imaging operation control is performed in accordance with the position of the subject, the number of people, the age, the gender, the size of the face region, and the like.

In the image processing device according to the present technology, it is conceivable that the imaging operation control is focus control.

The focus control is performed, for example, by controlling an operation of the focus lens of the imaging device.

In the image processing device according to the present technology, it is conceivable that the display control unit generates a defocus map image in a color in accordance with the defocus amount at each position of the captured image.

Thus, the difference in the value of the defocus amount of each position of the imaging device is displayed as a difference in color in the defocus map image.

In the image processing device according to the present technology, it is conceivable that the operation control unit performs imaging operation control in response to a user operation on a defocus map image.

Thus, the defocus amount of each position of the captured image is changed by adjusting the focus position in the captured image in response to the user operation.

In the image processing device according to the present technology, it is conceivable that the display control unit generates a defocus map image using a defocus amount display icon in which a display mode is different in accordance with the defocus amount; and the operation control unit performs imaging operation control in response to a user operation on the defocus amount display icon in the defocus map image.

Thus, imaging operation control is performed in accordance with the change in the display mode of the defocus amount display icon in response to the user operation and the defocus amount of the position corresponding to the defocus amount display icon is changed in accordance with the imaging operation control.

In the image processing device according to the present technology, it is conceivable that the target region setting unit sets a face region detected through face detection in the captured image as the target region.

Thus, the focus position in the face region of the captured image is adjusted.

In the image processing device according to the present technology, it is conceivable that the target region setting unit sets a pupil region detected through pupil detection in the captured image as the target region.

Thus, the focus position in the pupil region of the captured image is adjusted.

According to another aspect of the present technology, an imaging device includes at least the map data generation unit and the imaging operation control unit. According to still another aspect of the present technology, an image processing method includes: generating defocus map data which is calculated from phase difference information detected by a phase difference detection unit and indicates defocus amounts at a plurality of positions of a captured image by an imaging element unit; and performing imaging operation control using the generated defocus map data.

According to still another aspect of the present technology, a program causes an information processing device to perform processing corresponding to the image processing method.

### BRIEF DESCRIPTION OF DRAWINGS

FIG. 1 is a diagram illustrating devices used in an embodiment of the present technology.

FIG. 2 is a diagram illustrating devices used in the embodiment.

FIG. 3 is a block diagram illustrating an imaging device according to the embodiment.

FIG. 4 is a diagram illustrating an imaging element unit according to the embodiment.

FIG. 5 is a block diagram illustrating a computer device according to the embodiment.

FIG. 6 is a diagram illustrating a functional configuration of an image processing device according to the embodiment.

FIG. 7 is a diagram illustrating defocus map data according to the embodiment.

FIG. 8 is a diagram illustrating depth map data according to the embodiment.

FIG. 9 is a diagram illustrating a display example of a captured image according to the embodiment.

FIG. 10 is a diagram illustrating a display example of a defocus map image according to the embodiment.

FIG. 11 is a diagram illustrating a display example of a depth map image according to the embodiment.

FIG. 12 is a diagram illustrating an imaging operation control example in a face region according to the embodiment.

FIG. 13 is a diagram illustrating an imaging operation control example in a pupil region according to the embodiment.

FIG. 14 is a diagram illustrating a display example of a defocus amount display icon according to the embodiment.

FIG. 15 is a diagram illustrating an imaging operation control example of a defocus amount display icon according to the embodiment.

FIG. 16 is a diagram illustrating an imaging operation control example of the defocus amount display icon according to the embodiment.

FIG. 17 is a diagram illustrating an imaging operation control example of the defocus amount display icon according to the embodiment.

FIG. 18 is a flowchart illustrating a processing example according to a first embodiment.

FIG. 19 is a flowchart illustrating a processing example according to the first embodiment.

FIG. 20 is a flowchart illustrating a processing example according to a second embodiment.

FIG. 21 is a flowchart illustrating a processing example according to the second embodiment.

FIG. 22 is a flowchart illustrating a processing example according to a third embodiment.

FIG. 23 is a flowchart illustrating a processing example according to the third embodiment.

FIG. 24 is a flowchart illustrating a processing example according to a fourth embodiment.

FIG. 25 is a flowchart illustrating a processing example according to the fourth embodiment.

### DESCRIPTION OF EMBODIMENTS

Hereinafter, embodiments will be described in the following order.

<1. Configurations of devices applicable as image processing device>

<2. Configuration of imaging device>

<3. Display mode of map image and imaging operation control>

<4. Processing performed by image processing device>

<5. Conclusion and modification examples>

In the following description, the same reference numerals are given for the same content and description thereof will be omitted.

Meanings of terms to be used are as follows.

Defocus map data indicates a defocus amount of each position in a captured image or a target region in the captured image. A defocus amount quantitively indicates a defocus (blurring) state at a certain position in a captured image and corresponds to, for example, a diameter of a defocus circle.

Depth map data indicates a subject distance of each position in a captured image or a target region in the captured image. A subject distance indicates a distance between a certain position in a captured image and a focus lens.

A defocus map data image is an image indicating a distribution of defocus amounts in the captured image generated using defocus map data or a target region in the captured image.

A depth map data image is an image indicating a distribution of subject distances in the captured image generated using depth map data or a target region in the captured image.

In the following description, the defocus map data and the depth map data are collectively referred to as map data, and the defocus map image and the depth map image are collectively referred to as map images.

### 1. Configurations of Devices Applicable as Image Processing Device

Hereinafter, an example in which an image processing device according to the present technology is realized mainly by an imaging device will be described, but the image processing device can be realized in any of various devices.

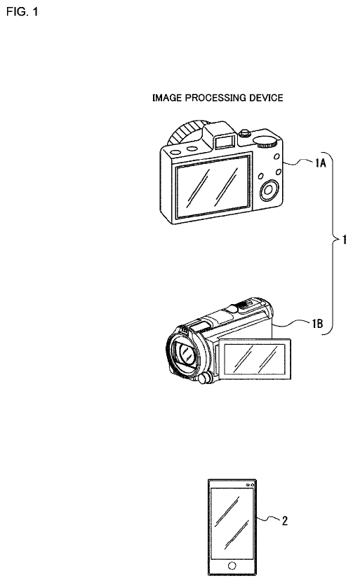

A device to which the technology of the present disclosure can be applied will be described. FIG. 1 illustrates examples of devices serving as an image processing device.

As devices serving as the image processing device, an imaging device 1 such as a digital still camera 1A or a digital video camera 1B and a portable terminal 2 such as a smartphone are assumed.

For example, in the imaging device 1, a microcomputer or the like inside the imaging device 1 performs image processing. By performing image processing on an image file generated through imaging by the imaging device 1, it is possible to perform image output and imaging operation control based on an image processing result. A captured image is displayed in the imaging device 1 in accordance with output image data.

The portable terminal 2 also has an imaging function, and thus can perform image output and imaging operation control based on an image processing result by performing the foregoing image processing on an image file generated through imaging. A captured image is displayed in the portable terminal 2 in accordance with output image data.

The present technology is not limited to the imaging device 1 or the portable terminal 2 and various kinds of devices serving as the image processing device are conceivable.

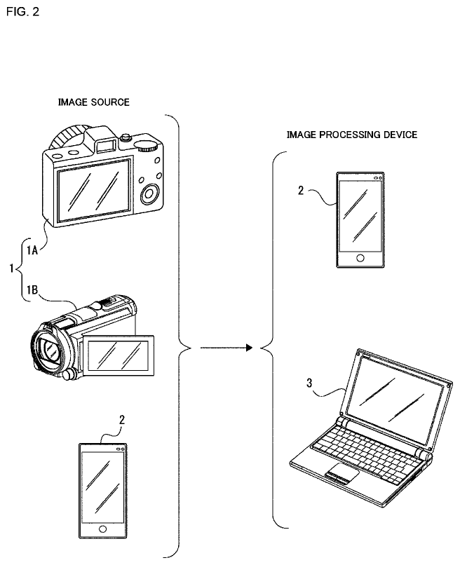

FIG. 2 illustrates examples of devices serving as an image source and devices serving as an image processing device that acquires an image file from the image source.

As the devices serving as the image source, the imaging device 1, the portable terminal 2, and the like are assumed. As the devices serving as the image processing device, the portable terminal 2, a personal computer 3, and the like are assumed.

The imaging device 1 or the portable terminal 2 serving as the image source transmits an image file obtained by capturing a moving image to the portable terminal 2 or the personal computer 3 serving as the image processing device through wired communication or wireless communication.

The portable terminal 2 or the personal computer 3 serving as the image processing device can perform the image processing on an image file acquired from the image source.

A certain portable terminal 2 or personal computer 3 can also serve as an image source for another portable terminal 2 or personal computer 3 serving as an image processing device.

When an image is output based on the image processing result, a captured image is displayed on the portable terminal 2 or the personal computer 3 serving as the image processing device.

The portable terminal 2 or the personal computer 3 serving as the image processing device can transmit an image file obtained in accordance with the image processing result to the imaging device 1 or the portable terminal 2 serving as the image source through wired communication or wireless communication to display a captured image on the imaging device 1 or the portable terminal 2.

There are various image sources and devices serving as the image processing device according to the embodiment, as described above. Hereinafter, an example in which the imaging device 1 is realized as an image processing device will be described.

### 2. Configuration of Imaging Device

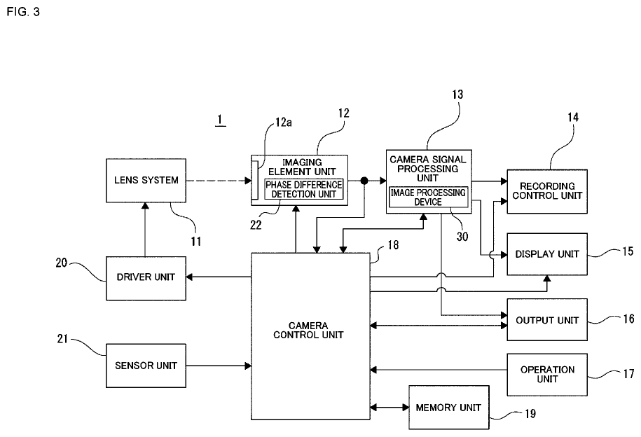

A configuration example of the imaging device 1 serving as the image processing device will be described with reference to FIG. 3.

As described with reference to FIG. 2, an image file captured by the imaging device 1 may be transmitted to the portable terminal 2 or the personal computer 3 serving as the image processing device through wired communication or wireless communication, and image processing may be performed in the portable terminal 2 or the personal computer 3 to which the image file has been transmitted.

As illustrated in FIG. 3, the imaging device 1 includes a lens system 11, an imaging element unit 12, a camera signal processing unit 13, a recording control unit 14, a display unit 15, an output unit 16, an operation unit 17, a camera control unit 18, a memory unit 19, a driver unit 20, a sensor unit 21, and a phase difference detection unit 22.

The lens system 11 includes lenses such as a cover lens, a zoom lens, and a focus lens and a diaphragm mechanism. The lens system 11 guides light (incident light) from a subject to condense the light on the imaging element unit 12.

The driver unit 20 includes, for example, a motor driver for a zoom lens driving motor, a motor driver for a focus lens driving motor, and a motor driver for a diaphragm mechanism driving motor.

The driver unit 20 applies a driving current to the corresponding driver in response to an instruction from the camera control unit 18 or the camera signal processing unit 13 to perform movement of the focus lens or the zoom lens, opening or closing of diaphragm blades of the diaphragm mechanism, or the like.

The diaphragm mechanism is driven by the diaphragm mechanism driving motor to control an amount of incident light on the imaging element unit 12 to be described below. The focus lens is driven by the focus lens driving motor and is used for focus adjustment. The zoom lens is driven by the zoom lens driving motor and is used for zoom adjustment.

The imaging element unit 12 includes, for example, a complementary metal oxide semiconductor (CMOS) or charge coupled device (CCD) type image sensor 12a (an imaging element). The image sensor 12a is configured by imaging pixels for imaging an image of a subject and image surface phase difference pixels for detecting a phase difference of an optical image of the subject.

The imaging element unit 12 performs, for example, correlated double sampling (CDS) processing and automatic gain control (AGC) processing, as well as analog/digital (A/D) conversion processing on an electrical signal obtained by photoelectrically converting light received by the image sensor 12a. The imaging element unit 12 outputs an imaging signal as digital data to the camera signal processing unit 13 or the camera control unit 18.

The phase difference detection unit 22 detects phase difference information used to calculate a defocus amount. The phase difference detection unit 22 is, for example, an image surface phase difference pixel in the imaging element unit 12.

The image surface phase difference pixel (the phase difference detection unit 22) detects a pair of phase difference signals and the imaging element unit 12 outputs the pair of phase difference signals detected by the image surface phase difference pixel. The phase difference signal is used for correlation calculation for calculating a defocus amount.

The imaging element unit 12 outputs the phase difference signal to the camera signal processing unit 13 or the camera control unit 18.

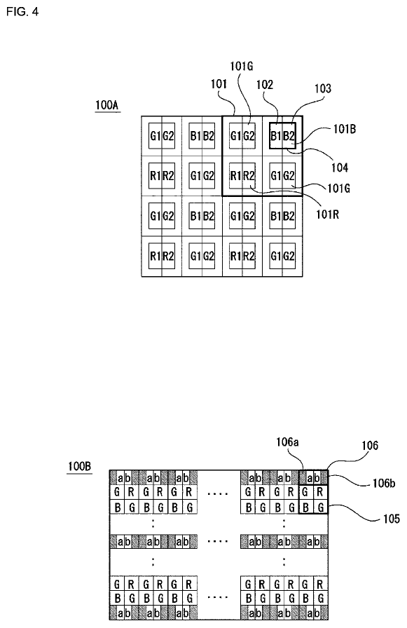

FIG. 4 illustrates an example of a pixel array of an image sensor 12a (an imaging element) in the present technology.

In FIG. 4, each part of the pixel arrays of imaging elements 100A and 100B is illustrated as an example of the pixel array of the image sensor 12a (the imaging element).

The imaging element 100A is an example formed as one pixel functioning as the imaging pixel and the image surface difference pixel.

On an imaging surface of the imaging element 100A, a plurality of pixel groups 101 formed by pixels of 2 columns×2 rows are provided. Each pixel group 101 is covered with color filters in a Bayer array. In each pixel group 101, a pixel 101R with R spectral sensitivity is disposed at a lower left position, pixels 101G with G spectral sensitivity are disposed at upper left and lower right positions, and a pixel 101B with B spectral sensitivity is disposed at an upper right position.

In order for the imaging element 100A to detect a phase difference signal, each pixel retains a plurality of photodiodes (photoelectric conversion portions) for one microlens 104. Each pixel includes two photodiodes 102 and 103 arrayed in 2 columns×1 row.

In the imaging element 100A, many pixel groups 101 formed by pixels of 2 columns×2 rows (the photodiodes of 4 columns×2 rows) are disposed on the imaging surface, and thus the imaging signal and the phase difference signal can be acquired.

In each pixel, light flux is separated by the microlens 104 and is formed as an image on the photodiodes 102 and 103. Then, the imaging signal and the phase difference signal are read in accordance with the signals from the photodiodes 102 and 103.

The imaging element is not limited to the foregoing configuration in which all the pixels have the plurality of photodiodes. As illustrated in the imaging element 100B, the image surface phase difference pixels may be separately provided apart from R, G, and B imaging pixels in the pixels.

On the imaging surface of the imaging element 100B, an imaging pixel group 105 formed by imaging pixels of 2 columns×2 rows for imaging an image of a subject and a pair of image surface phase difference pixels 106 for detecting a phase difference of optical images of the subject are provided. The one pair of image surface phase difference pixels 106 are separately disposed between the plurality of imaging pixels on the imaging surface.

In the one pair of phase difference detection pixels 106, for example, when a pupil region of the imaging lens is divided into two right and left division regions, a phase difference detection pixel 106a that receives the light flux incident from the left division region and a phase difference detection pixel 106b that receives the light flux incident from the right division region are provided. A phase difference signal of an image of the subject at the division regions obtained from the phase difference detection pixels 106a and 106b can be read.

In a region in which the phase difference detection pixel 106 is not provided, the camera signal processing unit 13 complements the phase difference with respect to each position by performing superresolution processing in image processing such as machine learning.

The imaging pixel group 105 is covered with color filters in a Bayer array. The imaging pixel group 105 can read an imaging signal from an electrical signal obtained by photoelectrically converting the received light.

As described above, the image surface phase difference pixels are integrated with the R, G, and B imaging pixels or are disposed in the periphery. Therefore, a defocus amount can be accurately calculated in pixel units of several pm from the read phase difference signal.

The phase difference detection unit 22 may be a phase difference sensor provided separately from the imaging element unit 12. For example, a configuration is conceivable in which a beam guided from the lens system 11 of the imaging device 1 is transmitted through a translucent mirror to be separated into transmitted light oriented toward the imaging element unit 12 and reflected light oriented toward the phase difference sensor, and the separated reflected light is received by the phase difference sensor to detect phase difference information.

Referring back to FIG. 3, the camera signal processing unit 13 includes, for example, an image processor such as a digital signal processor (DSP). In the camera signal processing unit 13, an image processing device 30 is provided to perform processing to be described below.

The camera signal processing unit 13 performs various kinds of signal processing on a digital signal (a captured image signal) from the imaging element unit 12. For example, the camera signal processing unit 13 performs preprocessing, synchronization processing, YC generation processing, various kinds of correction processing, resolution conversion processing, codec processing, and the like as camera processing.

In the preprocessing, clamping processing of clamping black levels of R, G, and B to predetermined levels, correction processing between color channels of R, G, and B, and the like are performed on the captured image signal from the imaging element unit 12.

In the synchronization processing, color separation processing is performed so that image data of pixels have all color components of R, G, and B. For example, in the case of an imaging element in which color filters with Bayer alignment are used, demosaic processing is performed as the color separation processing.

In the YC generation processing, a luminance (Y) signal and a color (C) signal are generated (separated) from the image data of R, G, and B.

In the resolution conversion processing, the resolution conversion processing is performed on the image data subjected to various kinds of signal processing.

In the codec processing of the camera signal processing unit 13, for example, encoding processing for recording or communication or file generation is performed on the image data subjected to the foregoing various kinds of processing. For example, an image file MF is generated with an MP4 format or the like used to record a moving image and a sound in conformity with MPEG-4. As still image file, it is conceivable that a file with a format such as joint photographic experts group (JPEG), a tagged image file format (TIFF), or a graphics interchange format (GIF) is generated.

The camera signal processing unit 13 also generates metadata added to the image file using information from the camera control unit 18 or the like.

In FIG. 3, a sound processing system is not illustrated. However, actually, a sound recording system and a sound processing system may be included, and the image file may include sound data along with image data serving as a moving image.

The recording control unit 14 performs recording and reproducing in a recording medium configured as, for example, a nonvolatile memory. The recording control unit 14 performs, for example, processing of recording a thumbnail image or an image file such as a moving-image data or still image data, the generated defocus map data, and the like in a recording medium.

A variety of actual forms of the recording control unit 14 can be considered. For example, the recording control unit 14 may be configured as a flash memory and a writing/reading circuit embedded in the imaging device 1 or may be formed as a card recording and reproducing unit that performs recording, reproducing, accessing on a recording medium which is detachably mounted on the imaging device 1, for example, a memory card (a portable flash memory or the like). As the form embedded in the imaging device 1, a hard disk drive (HDD) or the like may be realized.

The display unit 15 is a display unit that performs various kinds of display for an imaging person and is, for example, a viewfinder or a display panel configured by a display device such as a liquid crystal panel (LCD) or an organic electro-luminescence (EL) display disposed in the casing of the imaging device 1.

The display unit 15 displays various kinds of display on a display screen based on an instruction from the camera control unit 18.

For example, image data of a captured image subjected to the resolution conversion for display by the camera signal processing unit 13 is supplied, and the display unit 15 performs display based on the image data of the captured image in response to an instruction from the camera control unit 18 Thus, a so-called through-image (a monitoring image of a subject) which is a captured image during standby is displayed.

The display unit 15 displays a reproduced image of the image data read from the recording medium in the recording control unit 14.

The display unit 15 displays various operation menus, icons, messages, and the like, that is, a graphical user interface (GUI), on a screen based on an instruction from the camera control unit 18.

The output unit 16 performs data communication, network communication, or the like with an external device in a wired or wireless manner.

For example, captured-image data (a still image file or a moving-image file) is transmitted and output to an external display device, recording device, or reproducing device or the like.

The output unit 16 is a network communication unit and may perform communication, for example, through various networks such as the Internet, a home network, and a local area network (LAN) to transmit and receive various kinds of data with a server, a terminal, and the like on the networks.

The operation unit 17 is a generic input device used for a user to perform various kinds of operation inputs. Specifically, the operation unit 17 indicates various kinds of operators (keys, a dial, a touch panel, a touch pad, and the like) provided in the casing of the imaging device 1.

The operation unit 17 detects a user operation and a signal in accordance with an input operation is transmitted to the camera control unit 18.

The camera control unit 18 is configured by a microcomputer (an arithmetic processing device) including a central processing unit (CPU).

The memory unit 19 stores information or the like used for processing by the camera control unit 18. The illustrated memory unit 19 overall indicates, for example, a read-only memory (ROM), a random access memory (RAM), a flash memory, and the like.

The memory unit 19 may be a memory region embedded in a microcomputer chip serving as the camera control unit 18 or may be configured by a separate memory chip.

The camera control unit 18 controls the whole imaging device 1 by executing a program stored in the ROM, the flash memory, or the like of the memory unit 19. For example, the camera control unit 18 controls an operation of each necessary unit with regard to control of a shutter speed of the imaging element unit 12, instructions of various kinds of signal processing in the camera signal processing unit 13, acquisition of lens information, an imaging operation or a recording operation in response to an operation by the user, starting/ending control of the moving image recording, a reproduction operation for the recorded image file, a change in autofocus (AF) control and manual focus (MF) control, operations of the lens system 11 such as zoom, focus, diaphragm adjustment in a lens barrel, and a user interface operation.

The RAM of the memory unit 19 is used to temporarily store data, a program, or the like as a working area used for the CPU of the camera control unit 18 to process various kinds of data.

The ROM or the flash memory (nonvolatile memory) of the memory unit 19 is used to store application programs for various operations, firmware, and the like in addition to an operating system (OS) used for the CPU to control each unit and a content file such as an image file.

The sensor unit 21 overall indicates any of various sensors mounted on the imaging device 1. As the sensor unit 21, for example, a positional information sensor, an illuminance sensor, an acceleration sensor, or the like is mounted.

The foregoing imaging device 1 performs image processing on the image file generated through imaging.

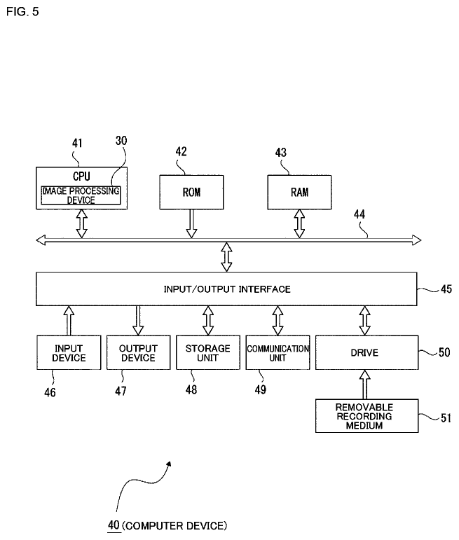

When the portable terminal 2 or the personal computer 3 performs image processing, the portable terminal 2 or the personal computer 3 can be realized as, for example, the computer device 40 that has the configuration illustrated in FIG. 5.

In FIG. 5, a central processing unit (CPU) 41 of the computer device 40 performs various kinds of processing in accordance with a program stored in a read-only memory (ROM) 42 or a program loaded from the storage unit 48 to a random access memory (RAM) 43. In the RAM 43, the CPU 41 performs various kinds of processing and necessary data or the like are also appropriately stored. In the CPU 41, the image processing device 30 is provided.

The CPU 41, the ROM 42, and the RAM 43 are connected to each other via a bus 44. An input/output interface 45 is also connected to the bus 44.

An input device 46 configured as a keyboard, a mouse, a touch panel, or the like, an output device 47 configured by a display such as a liquid crystal display (LCD), a cathode ray tube (CRT), or an organic electroluminescence (EL) panel, a speaker, and the like, and a hard disk drive (HDD) are connected to the input/output interface 45.

The output device 47 displays an image for various kinds of image processing, a processing target moving image, or the like on a display screen in response to an instruction from the CPU 41. The output device 47 displays various operation menus, icons, and messages, that is, a graphical user interface (GUI) in response to an instruction from the CPU 41.

A storage unit 48 configured by a hard disk, a solid-state memory, or the like or a communication unit 49 configured by a modem or the like are connected to the input/output interface 45 in some cases.

The communication unit 49 performs communication processing via a transmission path such as the Internet or performs communication such as wired/wireless communication or bus communication with various devices.

A drive 50 is connected to the input/output interface 45 as necessary so that a removable recording medium 51 such as a magnetic disk, an optical disc, a magneto-optical disc, or a semiconductor memory is appropriately mounted.

The drive 50 can read a data file such as an image file or various computer programs from the removable recording medium 51. The read data file is stored in the storage unit 48 or an image or a sound included in the data file is output to the output device 47. A computer program or the like read from the removable recording medium 51 is installed to the storage unit 48 as necessary.

In the computer device 40, for example, software for image processing of the image processing device according to the present disclosure can be installed through network communication of the communication unit 49 or via the removable recording medium 51. Alternatively, the software may be stored in advance in the ROM 42, the storage unit 48, or the like.

The computer device 40 is not limited to the configuration in which the single device is configured as in FIG. 5. A plurality of computer system may be configured as a system. The plurality of computer devices may include a computer device such as a server group (a cloud) which can be used by a cloud computing service.

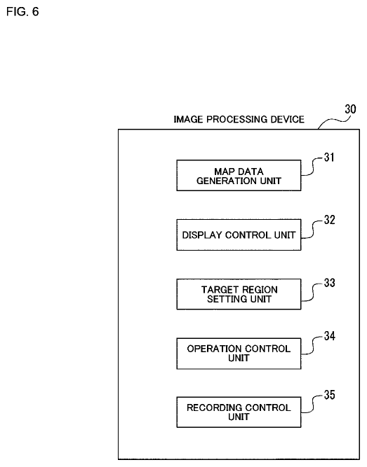

A functional configuration of the image processing device 30 will be described with reference to FIG. 6.

For example, the functional configuration of FIG. 6 is constructed in the image processing device 30 in accordance with the following software (an application program).

That is, the image processing device 30 includes functions as a map data generation unit 31, a display control unit 32, a target region setting unit 33, an operation control unit 34, and a recording control unit 35.

The map data generation unit 31 generates defocus map data that is calculated from a phase difference signal (phase difference information) detected by the image surface phase difference pixels in the imaging element unit 12 and indicate defocus amounts at a plurality of positions of a captured image by the imaging element unit 12.

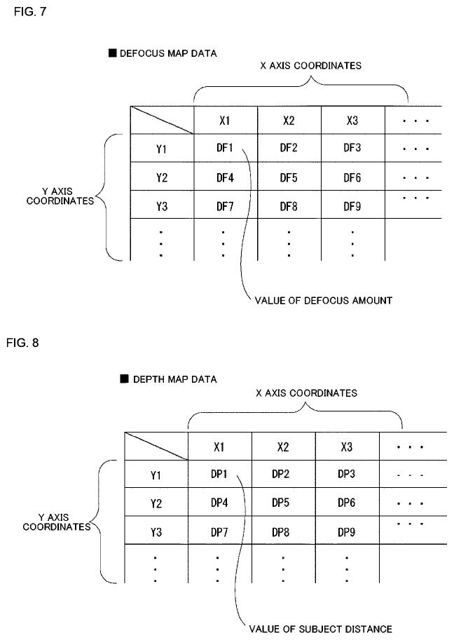

For example, when the X axis represents the horizontal direction of a captured image and the Y axis represents the vertical direction in FIG. 7, the map data generation unit 31 generates values of defocus amounts (DF1, DF2, DF3, . . . ) at positions specified by the X axis coordinates (X1, X2, X3, . . . ) and Y axis coordinates (Y1, Y2, Y3, . . . ) in the captured image as the defocus map data.

The map data generation unit 31 can calculate subject distances at a plurality of positions of a captured image by the imaging element unit 12 based on the generated defocus map data and lens information and generate depth map data indicating the calculated subject distances.

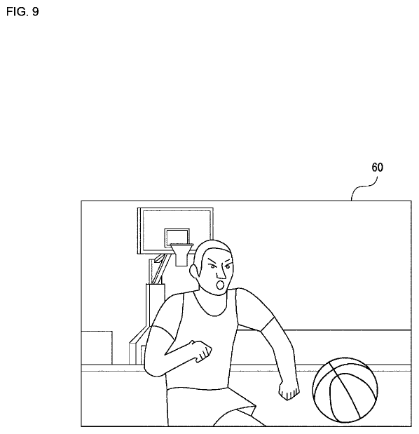

For example, in FIG. 8, the map data generation unit 31 generates values of the subject distances (DP1, DP2, DP3, . . . ) at positions specified by the X axis coordinates (X1, X2, X3, . . . ) and Y axis coordinates (Y1, Y2, Y3, . . . ) in the captured image as the depth map data.

The display control unit 32 generates a defocus map image indicating a distribution of defocus amounts in the captured image using the defocus map data generated by the map data generation unit 31 and performs display control.

The display control unit 32 displays the defocus map image on the display unit 15 of the imaging device 1, for example, by superimposing the defocus map image on the captured image.

The display control unit 32 switches whether to superimpose and display the defocus map image on a normal captured image at a predetermined timing.

The display control unit 32 may display the defocus map image through α blending (processing of superimposing a translucent image by multiplying an α value) or may display the defocus map image by outputting the defocus map image alone.

The display control unit 32 generates a depth map image indicating a distribution of subject distances in the captured image using the depth map data generated by the map data generation unit 31 and performs display control.

The display control unit 32 switches whether to superimpose and display the depth map image on a normal captured image at a predetermined timing.

The display control unit 32 starts or ends display of the map image at various timings. For example, the display control unit 32 starts or ends display of the map image in response to a user operation.

For example, the display control unit 32 can display the map image at other various timings such as a start timing of a focus control operation in an autofocus mode, a focus timing through a focus control operation in the autofocus mode, a detection timing of a focus adjustment operation or a diaphragm adjustment operation by a user in a manual focus mode, and a recording start timing of a captured image.

The display control unit 32 ends the display control of the map image, for example, after a predetermined time passes from the display of the map image.

The display control unit 32 can also perform display control for switching the defocus map image and the depth map image.

The target region setting unit 33 sets a target region in a captured image. The target region is a whole or partial region of the captured image.

The target region setting unit 33 sets the target region in accordance with, for example, captured image content.

The captured image content is, for example, a setting mode in the imaging device 1. For example, when a face detection mode is set, the target region setting unit 33 detects a face region through image analysis processing and sets the detected face region as the target region. When a pupil detection mode is set, the target region setting unit 33 detects a pupil region through image analysis processing and sets the detected pupil region as a target region.

The target region setting unit 33 can set, for example, a region in a captured image designated through a user operation as the target region.

When the target region setting unit 33 sets the target region in the captured image, the map data generation unit 31 can generate the defocus map data or the depth map data in the target region.

The operation control unit 34 performs, for example, imaging operation control in the target region using the defocus map data generated by the map data generation unit 31. The operation control unit 34 performs, for example, operation control on the focus lens or the diaphragm mechanism of the lens system 11. The operation control unit 34 performs focus control by controlling an operation of the focus lens and performs control to cause a change in a depth of field by controlling the operation of the diaphragm mechanism.

The operation control unit 34 may control an imaging operation and perform the imaging operation control based on the phase difference signal acquired without using the defocus map data.

The recording control unit 35 records the defocus map data or the depth map data generated by the map data generation unit 31 as additional information regarding frame data of the captured image.

The example in which the image processing device 30 is embedded in the camera signal processing unit 13 of the imaging device 1 has been described in FIG. 3. The image processing device 30 may be embedded in the camera control unit 18 or may be embedded in the CPU 41 of the computer device 40 illustrated in FIG. 5.

Each function of the image processing device 30 may be realized by the plurality of image processing devices 30. For example, the image processing device 30 embedded in the camera signal processing unit 13 may have the functions of the map data generation unit 31, the target region setting unit 33, and the recording control unit 35. The image processing device 30 embedded in the camera control unit 18 may have the functions of the display control unit 32 and the operation control unit 34.

The imaging device 1 including the image processing device 30 that has the functions of FIG. 6 performs the process for realizing the present technology.

### 3. Display Mode of Map Image and Imaging Operation Control

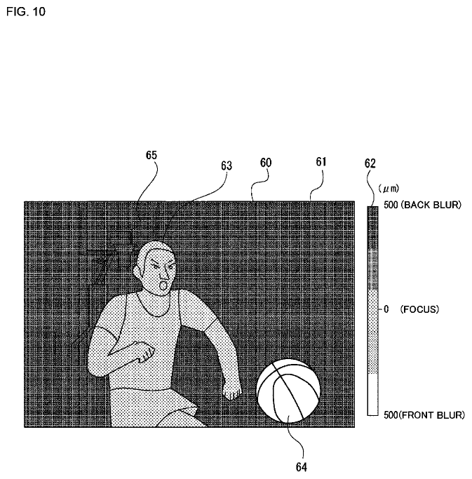

Examples of a display mode of the map image and imaging operation control according to the present technology will be described with reference to FIGS. 9 to 17. FIGS. 9 to 11 illustrate an example of a display mode of the map image in which a whole captured image is set as a target region.

FIG. 9 illustrates a display example of the captured image captured by the imaging device 1. FIG. 9 illustrates a state in which the map image is not superimposed and displayed on a captured image 60. The captured image 60 is displayed as a live view image on the display unit 15 of the imaging device 1. The display unit 15 is, for example, a liquid crystal monitor or a viewfinder.

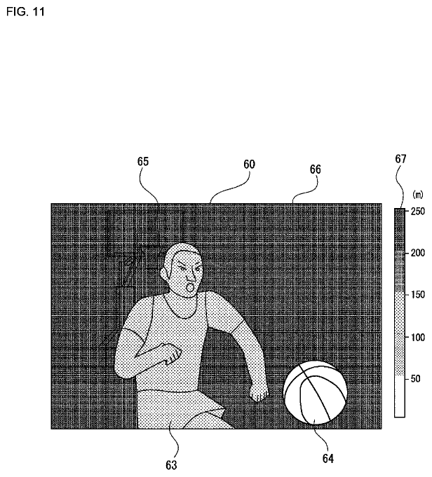

FIG. 10 illustrates a display example of the defocus map image in which information regarding a defocus amount is added to the captured image. In FIG. 10, a defocus map image 61 and a defocus meter 62 are displayed on the display unit 15 of the imaging device 1.

The defocus map image 61 is superimposed and displayed on the captured image 60 and is displayed like a heatmap, for example, by performing coloring in accordance with a defocus amount of each position of the captured image. Thus, the defocus amount of each position in the whole captured image can be visually recognized.

In FIG. 10, the coloring is schematically stippled and a difference in density of the stippling is indicated as a difference in color. The defocus map image 61 is generated by the image processing device 30 using the defocus map data.

The defocus meter 62 indicates a value of a defocus amount corresponding to color of the defocus map image 61. Thus, it can be easy to visually recognize how the color displayed in the defocus map image 61 is shown as the defocus amount.

In this way, when the defocus map image 61 is displayed, it is easy to visually recognize a distribution of the defocus amounts of the positions of the captured image 60 in accordance with a change in the color.

For example, in FIG. 10, it is possible to visually check that a subject 63 enters a focus state, a subject 64 located in front of the subject 63 enters a front blurring state due to a decrease in the degree of focus, and a subject 65 located in the back of the subject 63 enters back blurring due to the decrease in the degree of focus.

In FIG. 10, it is possible to visually recognize the quantitative degree of focus (a blurring state in accordance with front and back blurring amounts) in the whole image as in the background including the subjects 63, 64, and 65 in the captured image 60. Thus, for example, when a user performs a manual focus operation, a focus operation can be performed in consideration of the degree of focus of the whole captured image.

FIG. 11 illustrates a display example of the depth map image of a captured image. In FIG. 11, a depth map image 66 and depth meter 67 are displayed on the display unit 15 of the imaging device 1.

The depth map image 66 is superimposed and displayed on the captured image 60 and coloring is performed in accordance with a subject distance of each position of the captured image 60. In FIG. 11, a difference in the subject distance is schematically stippled and a difference in density of the stippling is indicated as the difference in the subject distance. The depth map image 66 is generated by the image processing device 30 using the depth map data.

The defocus meter 67 indicates a value of a substance distance corresponding to color of the depth map image 66. Thus, it can be easy to visually recognize the subject distance corresponding to the color displayed in the depth map image 66.

In this way, when the defocus map image 61 is displayed, it is easy to visually recognize the subject distance of each position of the captured image 60 in accordance with a change in the color.

For example, in FIG. 11, it is possible to visually check that the subject 65 is located in the back of the subject 63 and the subject 64 is located in front of the subject 63. Thus, for example, the depth of field can be adjusted in consideration of the subject distance of each subject in the whole captured image.

A partial region corresponding to a range of a predetermined defocus amount can also be displayed as a target region in the defocus map image. Thus, it can be easy to visually check the region with the predetermined defocus amount.

Only a region corresponding to the range of the predetermined subject distance can also be displayed as a target region in the depth map image. Thus, it can be easy to visually check the region at the predetermined subject distance.

The range of the defocus amount and the range of the subject distance may be set in advance or may be set appropriately through a user operation.

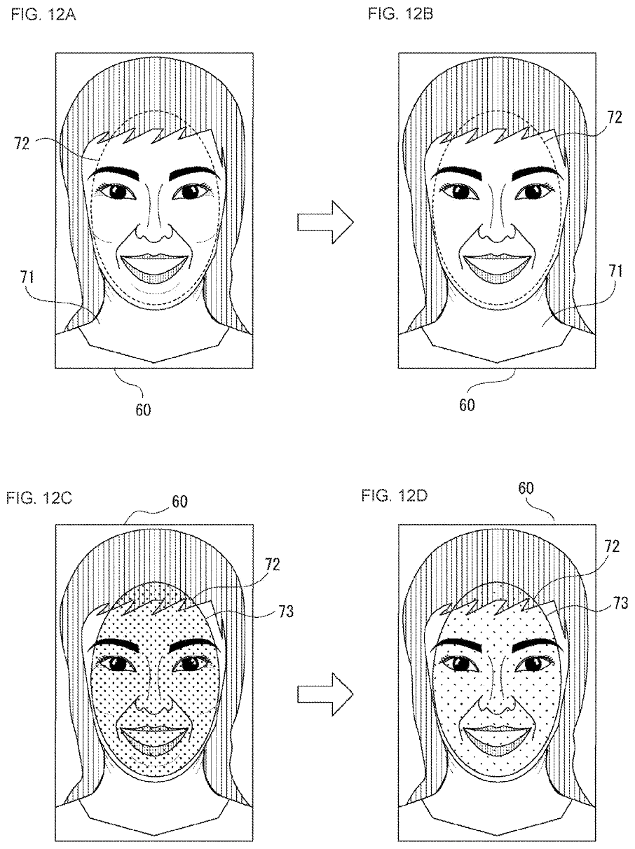

FIGS. 12 to 17 illustrate an example of imaging operation control performed on a partial target region in a captured image.

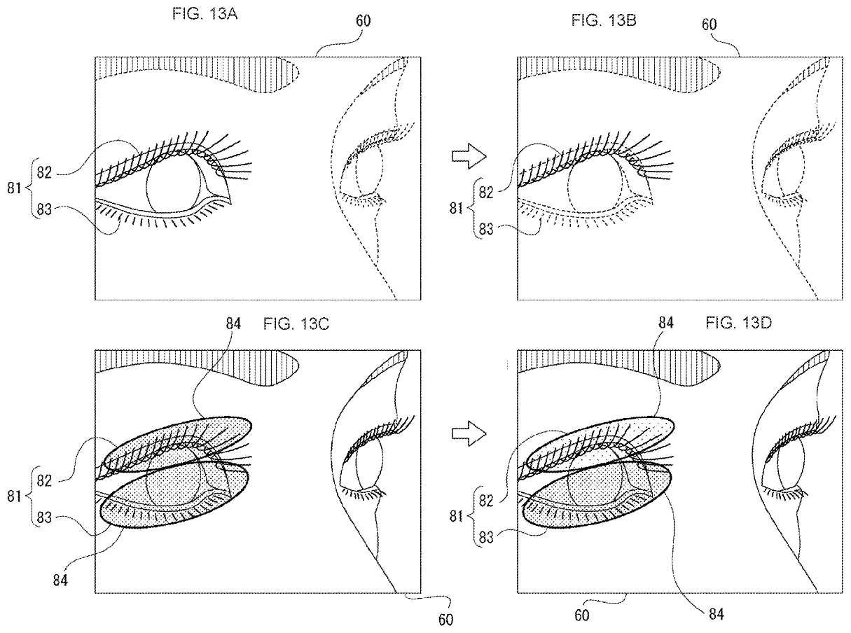

FIGS. 12 and 13 illustrate an example in which a focus position is automatically adjusted in accordance with a target region detected from the captured image.

An example in which a focus position is adjusted when a face region of a subject is a target region will be described with reference to FIG. 12.

In FIG. 12A, the captured image 60 is in a state in which a focus position of the target region (the face region) is not adjusted and is an image in which wrinkles are relatively are conspicuous in the corner of eyes, the cheek, the chin, and the like in the face region 72 of the subject 71. This is because the details of a subject can be displayed in more detail with high resolution pixels and high definition of the imaging device 1 (the image processing device 30).

Next, the captured image in which the focus position of the target region (the face region) is adjusted with respect to the captured image 60 in FIG. 12A is illustrated in FIG. 12B.

In FIG. 12B, a face region 72 of the subject 71 in the captured image 60 is detected and imaging operation control is performed to shift the detected face region 72 minutely from the focus position. Thus, blurring slightly occurs in the face region 72 of the subject 71, and the corner of eyes, the cheek, the chin, and the like of the face region 72 cannot be conspicuous.

A shift amount from the focus position can be set in accordance with an attribute of the detected face region 72, that is, the number of face regions 72, the size, the position, the age, the gender, or the like of the face region 72. The shift amount from the focus position may be set in advance or may be set through a user operation.

The imaging operation control is automatically performed when the face region 72 is detected in the captured image 60.

While a subject can be displayed more clearly with an improvement in imaging performance of the imaging device 1 (the image processing device 30), reality of the subject may be considerably achieved. Thus, depending on a situation in which the imaging is performed, there is concern of an unnatural impression being given to a user who has browsed the captured image. However, depending on a subject in a captured image, by slightly shifting the subject purposely from the focus position, it is possible to provide the captured image which does not give a discomfort to the user.

As illustrated in FIGS. 12C and 12D, a defocus map image 73 can also be superimposed and displayed on the face region 72. In the example of the defocus map image 73, a distribution of defocus amounts is displayed in the face region 72 with a color in accordance with the defocus amounts.

FIG. 12C illustrates the defocus map image 73 when the face region 72 becomes a focus position. FIG. 12D illustrates the defocus map image 73 after imaging operation control is performed to slightly shift the face region 72 from the focus position.

Thus, a change in the defocus amount in the face region 72 can be visually recognized.

An example in which a blurring state is adjusted by adjusting a depth of field in each portion of a pupil region when the pupil region of the subject is set as a target region will be described with reference to FIG. 13.

FIG. 13A illustrates a state in which both an eyelash region 82 and a region 83 other than the eyelash in the pupil region 81 of the captured image 60 are in a state in which there is no blurring. FIG. 13B illustrates a state in which the eyelash region 82 is not blurred and the region 83 other than the eyelash is blurred. In FIGS. 13A and 13B, a region in which there is no blurring is indicated by a solid line and a region in which blurring occurs is indicated by a dotted line.

As a scheme of expressing a captured image, for example, in the eyelash region 82 and the region 83 other than the eyelash in the pupil region 81, the eyelash region 82 is not clearly blurred to be displayed and the region 83 other than the eyelash is slightly blurred. Since an expression of a minute depth of a pupil is reflected on a monitor with the high resolution pixels and the high definition, such a highly accurate expression scheme can be used.

For example, by setting the depth of field in the pupil region 81 in advance, it is possible to automatically perform F value control and adjust a blurring state of the eyelash region 82 and the region 83 other than the eyelash.

An adjustment amount of the depth of field in the pupil region 81 may be set in advance in accordance with, for example, information such as the size, the position, the age, gender, or the like of the detected pupil region or may be set through a user operation.

According to the foregoing example, it is possible to ascertain a blurring style of the eyelash and the pupil in terms of a balance and automatically control an F value so that an optimum depth of field.

As illustrated in FIGS. 13C and 13D, defocus map images 84 of the eyelash region 82 and the region 83 other than the eyelash in the pupil region 81 can also be superimposed and displayed. In the example of the defocus map images 84, a distribution of the defocus amounts of the pupil region 81 is displayed with a color in accordance with the defocus amount of each portion. Thus, it is possible to visually recognize the defocus amount of each position in the pupil region 84.

FIG. 13C illustrates a state in which both the eyelash region 82 and the region 83 other than the eyelash in the pupil region 81 have the same defocus amount. From this state, the defocus amount of the eyelash region 82 is changed, for example, as illustrated in FIG. 13D, by adjusting the depth of field.

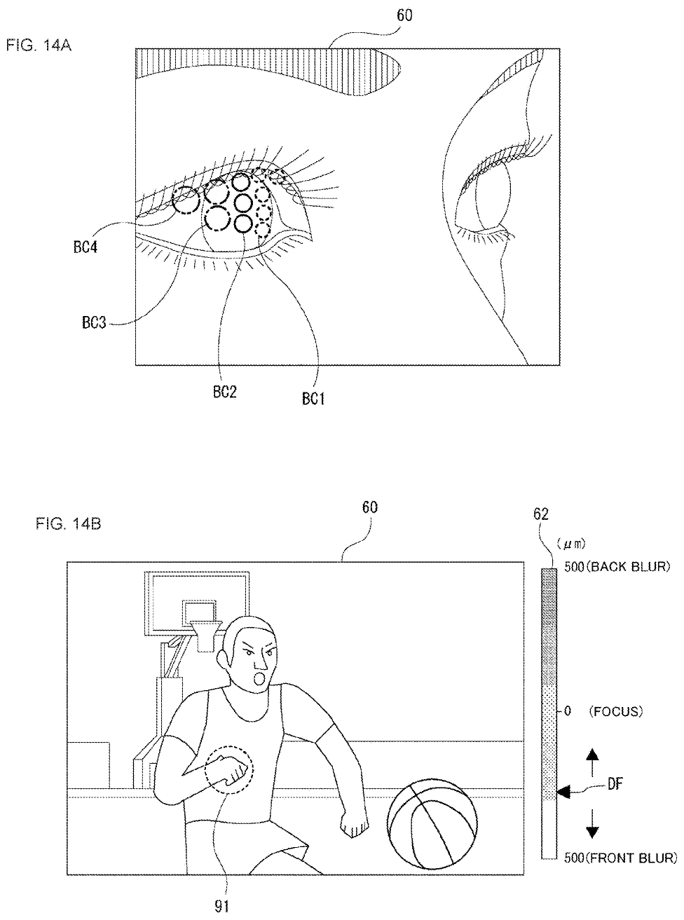

Next, an example in which another display mode of the defocus map image, that is, the defocus amount of each position in the captured image, is displayed with a defocus amount display icon will be described with reference to FIG. 14.

The defocus amount display icon can be displayed, for example, with any of various signs such as a circular or rectangular frame or a bar indicating a blurring amount.

In an example illustrated in FIG. 14A, the defocus amount display icon is circular and circular icons BC with different diameters in accordance with the defocus amount are displayed in the defocus map image.

Circular icons BC1, BC2, BC3, and BC4 with different diameters are displayed in accordance with the defocus amount at each position of the captured image 60. For example, the diameter of the circular icon BC is an absolute value of the defocus amount and the circular icon is displayed so that a blurring state increases as the diameter of the circular icon BC increases.

The user can view the size of the circular icon BC displayed as the defocus map image and recognize the defocus amount of each position in the captured image 60 visually and sensually.

The display mode is useful, for example, when a distribution of the defocus amount of the plurality of positions in a relatively narrow target region such as a pupil region of a subject is displayed.

In the example illustrated in FIG. 14A, for example, by pinching in or out the circular icon BC through a user operation on the touch panel to change the diameter of the circular icon BC, it is possible to adjust the defocus amount of the position corresponding to each circular icon BC.

For example, by increasing the diameter of the circular icon BC through a pinch-out operation, an operation of the focus lens or the diaphragm mechanism is controlled, and thus the defocus amount of the position corresponding to the circular icon BC increases. By decreasing the diameter of the circular icon BC through a pinch-in operation, an operation of the focus lens or the diaphragm mechanism is controlled, and thus the defocus amount of the position corresponding to the circular icon BC decreases.

FIG. 14B illustrates an example in which a defocus amount for a region in the captured image selected through an operation by the user is displayed with a defocus amount display icon (an arrow DF).

For example, when the user touches the touch panel and selects a region 91 in the captured image 60, a defocus amount of the region 91 is instructed with the arrow DF in the defocus meter 62.

In the example illustrated in FIG. 14B, by vertically sliding the arrow DF provided in the defocus meter 62 through a user operation and moving the arrow DF to a position of a desired defocus amount, an operation control is performed on the focus lens or the diaphragm mechanism so that the region 91 has the defocus amount indicated by the arrow DF.

Thus, the user can check a defocus amount of a certain position in the captured image and further can intuitively perform adjustment so that the desired defocus amount (a blurring state) is obtained.

In the region 91 selected by the user, a defocus map screen colored in accordance with the defocus amount illustrated in FIG. 12C or the like may be displayed. Thus, a change in the defocus amount (a change in the blurring state) by the operation can be intuitively recognized.

Further, a distribution of the whole amounts of the defocus captured image 60 in FIG. 14B may be colored and displayed, as illustrated in FIG. 10. Thus, when the user operates the arrow DF, the defocus amount of another region can be taken into consideration.

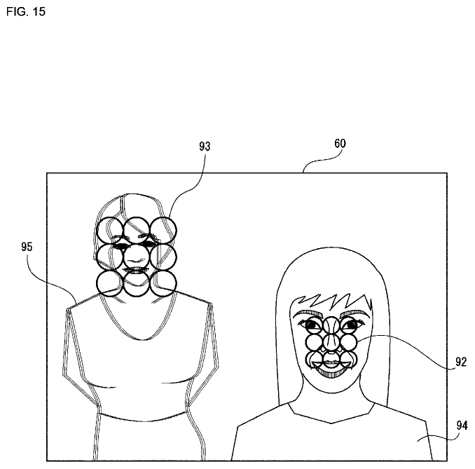

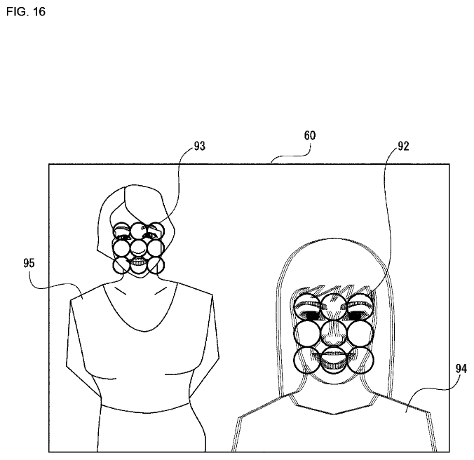

Next, a display mode of the defocus amount display icon in a plurality of subjects in a captured image and control of the display mode will be described with reference to FIGS. 15 to 17.

In an example of FIG. 15, icon groups 92 and 93 in which a plurality of circular icons (formed in 3 columns×3 rows, for example) are integrated as defocus amount display icons in the captured image 60 are displayed. The diameter of the circular icons that form the icon groups 92 and 93 indicates, for example, an absolute value of the defocus amount.

The icon groups 92 and 93 are displayed in, for example, regions of two portions selected through a user touching operation on the touch panel. In FIG. 15, face regions of subjects 94 and 95 in the captured image 60 are selected and the icon groups 92 and 93 are displayed.

The circular icon groups 92 and 93 are displayed with different sizes in accordance with the defocus amount of each position. In FIG. 15, blurring does not occur in the face region of the subject 94 (a focus position) and blurring occurs in the face region of the subject 95.

At this time, the user can adjust shift from each focus position at the positions corresponding to the icon groups 92 and 93 by performing an operation of changing the size of one of the icon groups 92 and 93. At this time, the shift from the focus position is adjusted by controlling movement of the focus lens in accordance with the change in the diameter of the circular icon of the icon group 92.

For example, the user can perform a pinch-out operation of the icon group 92 on the touch panel to increase the diameter of the circular icon of the icon group 92 to increase the defocus amount of the face region of the subject 94 by, and thus it is possible to shift the position from the focus position (the blurring state increases). At this time, when the icon group 92 increases, the icon group 93 relatively decreases, the region corresponding to the icon group 93 becomes close to focus, and thus the defocus amount of the face region of the subject 95 decreases (the blurring state decreases).

Conversely, when the user performs a pinch-in operation on the icon group 93, as illustrated in FIG. 16, it is possible to decrease the diameter of the circular icon of the icon group 93. Accordingly, the face region of the subject 95 corresponding to the icon group 93 shifted from the focus position in FIG. 15 becomes closes to the focus position, and thus the defocus of the region decreases (the blurring state decreases).

When the diameter of the circular icon of the icon group 93 decreases, the diameter of the circular icon of the icon group 92 relatively increases, and thus the face region of the subject 94 corresponding to the icon group 92 is shifted from the focus position. Therefore, the defocus amount of the region increases (the blurring state increases).

In this way, by displaying the defocus amount display icons indicating the defocus amounts in the two selected subjects, it is possible to visually check the blurring state of each subject and it is possible to adjust the blurring state based on that.

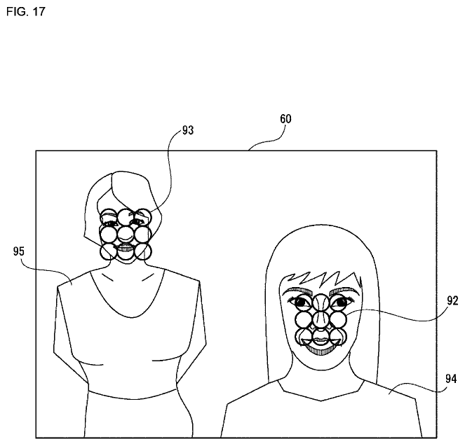

In FIGS. 15 and 16, the examples in which the blurring states of the subjects 94 and 95 are adjusted through the movement control of the focus lens have been described. As illustrated in an example of FIG. 17, it is possible to also adjust the blurring states of the subjects 94 and 95 through operation control of the diaphragm mechanism (F value control).

By controlling the F value through an operation of the diaphragm mechanism and deepening the depth of field, it is possible to set both the subjects 94 and 95 to the focus state. In this case, as illustrated in FIG. 17, the diameters of the circular icons of the circular icon groups 92 and 93 are displayed with the same size.

As described above, various modes are conceivable for the imaging operation control and the display control of the map image according to the present technology.

### 4. Processing Performed by Image Processing Device

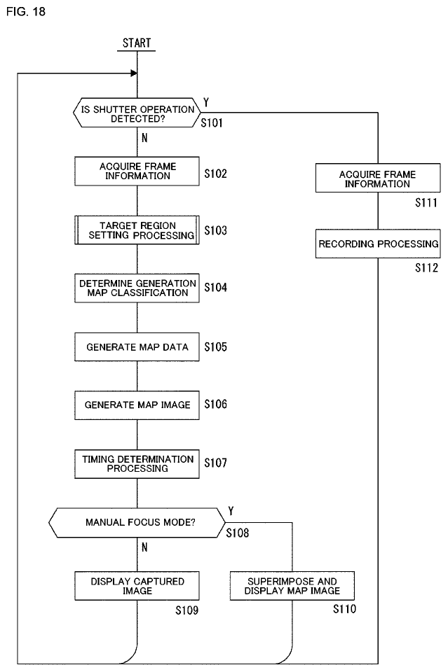

Processing performed in the image processing device to realize the display control of the map image and the imaging operation control according to the present technology will be described with reference to FIGS. 18 to 25.

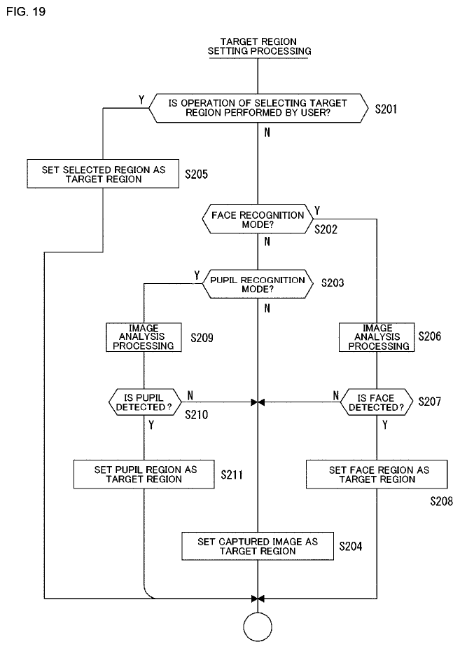

A first embodiment of the present technology will be described with reference to FIGS. 18 and 19.

The first embodiment is an example in which processing is performed to realize the display control of the map image by the image processing device 30 and the map image is displayed in a manual focus mode.

In FIG. 18, when a shutter operation by the user is not detected in step S101, the image processing device 30 causes the processing to proceed to step S102 to acquire frame information from the imaging element unit 12.

The frame information is, for example, various map data generated based on the phase difference signal from image data of one current frame. The image data of one frame mentioned here is image data processed for display by the camera signal processing unit 13.

In step S103, the image processing device 30 performs target region setting processing. Thus, the image processing device 30 sets a region in which the map data such as the defocus map data or the depth map data in the captured image is generated, that is, a target region.

Here, the details of the target region setting processing will be described with reference to FIG. 19.

The image processing device 30 checks in step S201 whether the user performs an operation of selecting a target region, checks in step S202 whether the imaging device 1 is set in a face recognition mode, and checks in step S203 whether the imaging device 1 is set in a pupil recognition mode. When the mode does not correspond to any mode, the image processing device 30 causes the processing to proceed to the order of steps S201, S202, S203, and S204.

In step S204, the image processing device 30 sets the captured image as a target region and ends the processing of FIG. 19. Thus, the whole captured image is set as the target region.

When the user performs the operation of selecting the target region in step S201, the image processing device 30 causes the processing to proceed to step S205 to set the selected region selected through the user operation as the target region and end the processing of FIG. 19. For example, the region 91 selected through the touch panel by the user is set as the target region as in FIG. 14B.

The selected region selected through the user operation may be a selected region set in advance by the user. For example, a predetermine defocus amount or subject distance is set and the image processing device 30 can also set a region corresponding to the predetermined defocus amount or subject distance as the target region in step S205. In this case, information generated in a previous frame may be used as the defocus amount or the subject distance in the captured image.

When the imaging device 1 is set to the face recognition mode in step S202, the image processing device 30 detects a face region by performing image analysis processing on the captured image in step S206.

When the face region is detected in step S206, the image processing device 30 causes the processing to proceed to the order of steps S207 and S208 to set the face region as the target region and end the processing of FIG. 19.

When the face region is not detected in step S206, the image processing device 30 causes the processing to proceed to the order of steps S207 and S204 to set the whole captured image and end the processing of FIG. 19.

When the imaging device 1 is set to the pupil recognition mode in step S203, the image processing device 30 detects a pupil region by performing the image analysis processing on the captured image in step S209.

When the pupil region is detected in step S209, the image processing device 30 causes the processing to proceed to the order of steps S210 and S211 to set the pupil region as the target region and end the processing of FIG. 19.

Conversely, when the face region is not detected in step S209, the image processing device 30 causes the processing to proceed to the order of steps S210 and S204 to set the whole captured image as the target region and end the processing of FIG. 19. Through the foregoing processing, the target region in which the map data is generated is set.

Referring back to FIG. 18, the image processing device 30 causes the processing to proceed from step S103 to step S104 to determine generation map classification. That is, the image processing device 30 generates the map data and determines which map data is generated between the defocus map data and the depth map data.

For example, the image processing device 30 determines the mode in which the defocus map data image or the depth map image is displayed and determines which map data is generated in accordance with the mode.

For example, when a user operation of controlling an operation of the diaphragm mechanism is detected, the image processing device 30 can also determine which map data is generated in accordance with the operation state of the user so that the depth map data is set to be generated.

In step S105, the image processing device 30 generates the map data of the defocus map data or the depth map data determined in step S104.

The image processing device 30 generates the defocus map data indicating the defocus amount of each position of the target region illustrated in FIG. 7 by performing correlation calculation of the defocus using the phase difference signal acquired in step S102 in the target region.

The image processing device 30 generates the depth map data indicating the subject distance at each position in the target region illustrated in FIG. 8 by calculating the subject distance based on the defocus information and the lens information in the generated defocus map data.

In step S104, the image processing device 30 may generate the one piece of map data to be displayed and may also generate both the pieces of data of the other map data. Thus, in step S112 to be described below, the defocus map data and the depth map data can be both recorded.

In step S106, the image processing device 30 generates a map image for the map data generated in step S105 and the map data determined to be displayed in step S104.

For example, as illustrated in FIGS. 10 and 11, the map image colored in accordance with the distribution of the defocus amounts or the subject distances is generated. For the defocus map image, the defocus map image in which the defocus amount of each position illustrated in FIG. 14 is displayed with the defocus amount display icon may be generated.

In step S107, the image processing device 30 performs timing determination processing of determining a display timing of the map image. Here, the image processing device 30 determines whether the imaging device 1 is set to the manual focus mode.

When the imaging device 1 is not set to the manual focus mode, the image processing device 30 determines that a timing is not the display timing of the map image in step S108 and causes the processing to proceed to step S109 to display only the captured image without superimposing and displaying the map image on the captured image.

When the imaging device 1 is set to the manual focus mode, the image processing device 30 determines in step S108 that the timing is the display timing of the map image and causes the processing to proceed to step S110 to superimpose and display the map image on the captured image.

In the timing determination processing of step S107, an example in which the image processing device 30 determines the display timing of the map image in response to detection of a user operation is also conceivable.

The user operation herein is an operation of switching on/off the display of the map image. For example, it is conceivable that a button for switching the display of the map image is provided and an on/off operation for the button is the user operation. As the user operation, various operations such as a half-push/full-push operation for a shutter button of the imaging device and a recording start/end operation for the captured image are conceivable. For example, in the case of the half-push/full-push operation for the shutter button of the imaging device, the half-push operation can be set as an operation of turning on the display of the map image and the full-push operation can be set as an operation of turning off the display of the map image. In the case of the recording start/end operation for the captured image, the recording start operation can be set as an operation of turning on the display of the map image and the recording end operation can be set as an operation of turning off the display of the map image. In this way, an operation of switching on/off the display of the map image can be allocated to various operations.

In this case, when the user operation of turning on the display of the map image is detected in step S107, the image processing device 30 determines that the timing is the display timing of the map image in step S108 and causes the processing to proceed to step S110 to superimpose and display the map image on the captured image.

When the user operation of turning off the display of the map image is detected in step S107, the image processing device 30 determines that the timing is not the display timing of the map image in step S108 and causes the processing to proceed to step S109 to display only the captured image without superimposing and displaying the map image on the captured image.

When the image processing device 30 ends the processing of step S109 or S110, the processing returns to step S101 to check detection of a shutter operation.

When the shutter operation is detected in step S101, the image processing device 30 causes the processing to proceed to step S111 to acquire frame information such as an imaging signal or a phase difference signal. At this time, the image processing device 30 also acquires the map data when there is the generated map data.

In step S112, the image processing device 30 performs processing of recording the acquired frame information and map data. The image processing device 30 records the map data as additional information of the frame information.

Thus, the defocus amount information at each position in the captured image is recorded as metadata of the captured image.

The image processing device 30 returns the processing to step S101 after the processing of step S112 and performs the foregoing processing.

As described above, the image processing device 30 performs the processing from steps S103 to S106 for each frame to record the map data constantly in step S112 when the shutter operation is detected in step S101, but the map data may not necessarily be stored in step S112.

In this case, the image processing device 30 may perform the processing in the order of steps S107 and S108 after step S102. When a determination flag is turned off in step S108, the processing may proceed to step S109.

Thus, it is unnecessary to display the map image, the image processing device 30 may display the captured image in step S109 without performing the processing from steps S103 to S106, that is, generating the map data. In this case, the image processing device 30 generates the map image from steps S103 to S106 in step S108 and then superimpose and displays the map image on the captured image in step S110

Through the foregoing processing, the image processing device 30 realizes the display control of the map image according to the first embodiment. Thus, for example, when the imaging device 1 switches the mode to the manual focus mode, the defocus map image 61 illustrated in FIG. 10 or the depth map image 66 illustrated in FIG. 11 is displayed.

When the imaging device 1 is in a face authentication mode, as illustrated in FIGS. 12C and 12D, the map image is displayed in the detected face region (the target region) at the display timing of the map image. Similarly, when the imaging device 1 is a pupil authentication mode, as illustrated in FIGS. 13C and 13D, the map image at each portion of the detected pupil region (the target region) is displayed. Accordingly, the user can recognize the defocus amount or the subject distance of each position in the target region of the captured screen 60 visually and intuitively. The user can perform the focus control or the F value control through the manual operation while taking the defocus amount or the subject distance of each position into consideration.

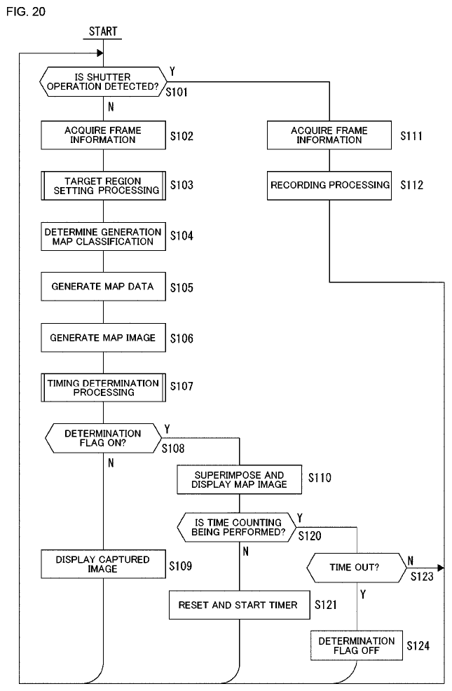

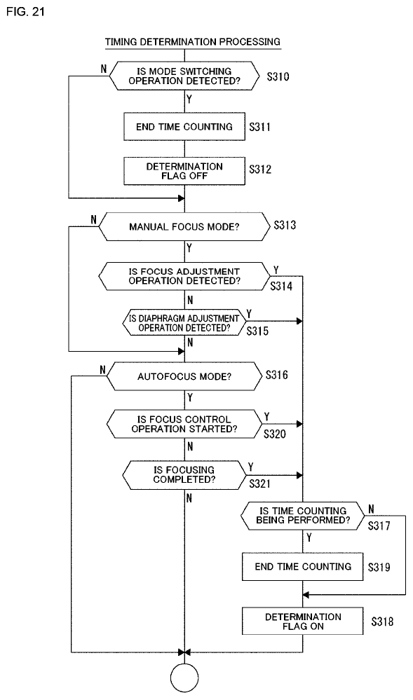

A second embodiment of the present technology will be described with reference to FIGS. 20 and 21.

In the second embodiment is an example in which processing is performed to realize the display control of the map image by the image processing device 30 and the map image is displayed at a predetermined timing in an autofocus mode or a manual focus mode. In the second embodiment, the display of the map image ends when the image processing device 30 displays the map image and then a predetermined time passes.

In FIG. 20, when the shutter operation is not detected in step S101, the image processing device 30 causes the processing to proceed to step S102 to acquire frame information from the imaging element unit 12. In step S103, the image processing device 30 performs the target region setting processing of FIG. 19 to set the target region in the captured image.

The image processing device 30 determines the generation map classification in step S104 and generates the map data in accordance with the determined map classification in step S105. In step S106, the image processing device 30 generates the map image using the generated map data.

In step S107, the image processing device 30 performs timing determination processing of determining a display timing of the map image.

The details of the timing determination processing according to the second embodiment will be described with reference to FIG. 21.

In step S310, the image processing device 30 determines whether a mode switching operation is detected. The mode switching mentioned here is switching from the manual focus mode to the autofocus mode or vice versa.

When the mode switching operation is not detected in step S310, the image processing device 30 causes the processing to proceed to step S313 to determine whether the imaging device 1 is set to the manual focus mode.

When the manual focus mode is set, the image processing device 30 determines in step S314 whether the focus adjustment operation is detected and determines in step S315 whether the diaphragm adjustment operation is detected.

When neither the focus adjustment operation nor the diaphragm adjustment operation is detected, the image processing device 30 causes the processing to proceed to step S316.

In step S316, the image processing device 30 determines whether the imaging device 1 is set to the autofocus mode.

When the autofocus mode is set, the image processing device 30 determines in step S320 whether the focus control operation is started and determines in step S321 whether focusing is completed through the focus control operation.

When the focus control operation is not started and the focusing is not completed through the focus control operation, the image processing device 30 ends the processing of FIG. 21.

On the other hand, when one of the focus adjustment operation or the diaphragm adjustment operation in the manual focus mode is detected in step S314 or S315 or when the focus control operation in the autofocus mode is started or the focusing is completed through the focus control operation in step S320 or S321, the processing proceeds to step S317.

In step S317, the image processing device 30 determines whether the time counting is being performed. The time counting which is being performed means that time counting is started and the timeout does not come. The time counting in the second embodiment is a state in which the counting is started along with display of the map image and the time counting which is being performed is a state in which the map image is superimposed and displayed on the captured image.

Here, since the time counting has not started, the image processing device 30 causes the processing to proceed from step S317 to step S318 to turn the determination flag on and end the processing of FIG. 21.

The determination flag is a flag indicating whether a timing is a display timing of the map image. The determination flag which is turned on indicates a timing at which the map image is superimposed and displayed on the captured image.

According to the foregoing timing determination processing, when the manual focus mode is set, a time at which one of the focus adjustment operation and the diaphragm adjustment operation is detected is the display timing of the map image. When the autofocus mode is set, the start of the focus control operation or the completion of the focusing through the focus control operation is the display timing of the map image.

Referring back to FIG. 20, the image processing device 30 determines in step S108 whether the determination flag is turned on. When the determination flag is turned off, the image processing device 30 displays only the captured image in step S109.

When the determination flag is turned on, the image processing device 30 causes the processing to proceed to step S110 to superimpose and displays the map image on the captured image.

In step S120, the image processing device 30 determines whether the time counting is being performed.

The case in which the time counting is not being performed means that the superimposition display of the map image is newly started. Therefore, the image processing device 30 resets the timer in step S121 and newly starts the time counting.

Here, it is conceivable that the timer is set to any of various times such as 5 seconds, 30 seconds, and 1 minute. Each different timer may be set using the detected start of the time counting as a trigger. For example, in the manual focus mode, when one of the focus adjustment operation and the diaphragm adjustment operation is detected, the timer may be set to 3 seconds. In the autofocus mode, the timer may be set to 1 minute due to the completion of the focusing through the focus control operation.

Thereafter, the image processing device 30 causes the processing to proceed to an order of steps S101 to S108, S110, and S120 and causes the processing to proceed to steps S123 and S101 when the time counting is performed. Thus, the time counting which is being performed is a state in which the map image is superimposed and displayed on the captured image.

When the time counting is timeout in step S123, the image processing device 30 turns the determination flag off in step S124. Thereafter, the image processing device 30 causes the processing to proceed to the processing after step S101 and causes the processing to proceed from step S108 to step S109 to display only the captured image. That is, the superimposition display of the map image on the captured image ends.

The superimposition display of the map image also ends when the manual focus mode and the autofocus mode is changed.

When the determination flag is turned on and the time counting is being performed, that is, the manual focus mode and the autofocus mode are changed in the superimposition display of the map image, the image processing device 30 causes the processing to proceed from step S310 to step S311 to end the time counting in the timing determination processing of FIG. 21, turns the determination flag off in step S312, and causes the processing to proceed to step S313.

Thus, when no trigger is detected in any of steps S314, S315, S320, and S321, the image processing device 30 causes the processing to proceed from step S108 to step S109 of FIG. 20 to end the superimposition display of the map image on the captured image and display only the captured image.

When the determination flag is turned on and the time counting is being performed and a trigger is newly detected in any of steps S314, S315, S320, and S321 of FIG. 21, processing of resetting the time counting and restarting the timing counting is performed. By resetting the time counting, it is possible to guarantee a display period of the map image set in response to the detection of each of steps S314, S315, S320, and S321.

Specifically, when a trigger is detected in any of steps S314, S315, S320, and S321, the image processing device 30 causes the processing to proceed to an order of steps S317 and S319 to end the time counting. The image processing device 30 causes the processing to proceed to an order of S318 and S108, S110, S120, and S121 of FIG. 20 to reset and start the time counting.

When the shutter operation is detected in step S101, the image processing device 30 causes the processing to proceed to step S111 to acquire the frame information such as the imaging signal or the phase difference signal. At this time, when there is the generated map data, the image processing device 30 also acquires the map data.

In step S112, the image processing device 30 performs processing of recording the acquired frame information and map data. The image processing device 30 returns the processing to step S101 after the processing of step S112 and performs the foregoing processing.

Through the foregoing processing, the image processing device 30 realizes the display control of the map image according to the second embodiment.

That is, at the timing at which the focus adjustment operation or the diaphragm adjustment operation in the manual focus mode is detected or the timing at which the start of the focus control operation in the autofocus mode or the completion of the focusing through the focus control operation is detected, the map image illustrated in FIGS. 10, 11, 12C, 12D, 13C, or 13D is superimposed and displayed on the target region of the captured image.

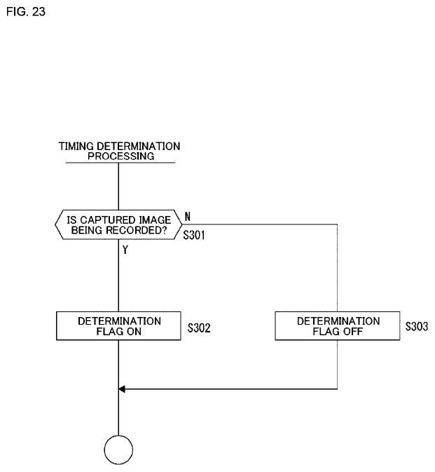

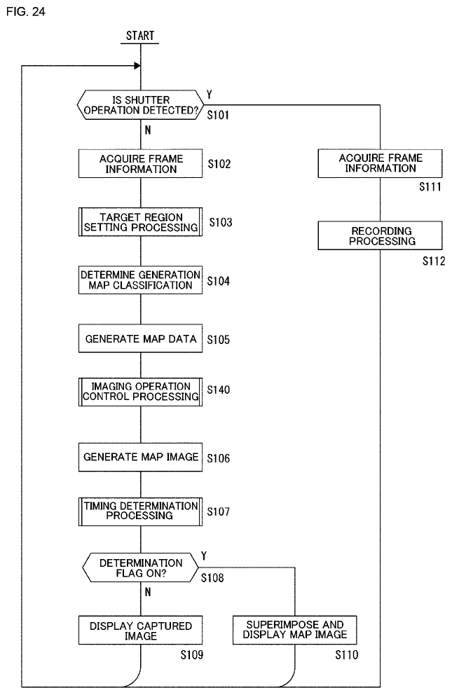

A third embodiment of the present technology will be described with reference to FIG. 23.

The third embodiment is an example in which processing is performed to realize the display control of the map image by the image processing device 30, and the map image is displayed during recording of a captured moving image and different display control is performed in accordance with an output device through which the image processing device 30 outputs image data.

The output device is a device in which an image processing device is embedded and is, for example, an imaging device such as a digital still camera or a digital video camera. The output device may be an external display device that displays an image based on an image signal output from a device in which the image processing device is embedded.

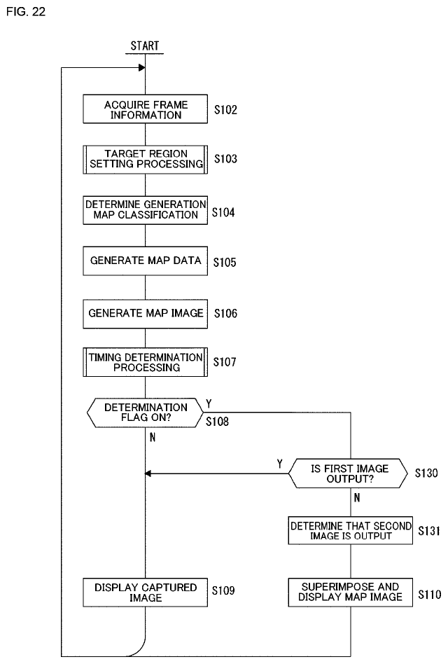

In FIG. 22, the image processing device 30 acquires frame information from the imaging element unit 12 in step S102. Here, as the frame information, information which is a through-image is acquired.

In step S103, the image processing device 30 performs the target region setting processing of FIG. 19 to set the target region in the captured image.

The image processing device 30 determines the generation map classification in step S104 and generates the map data in accordance with the determined map classification in step S105. In step S106, the image processing device 30 generates the map image using the generated map data.

In step S107, the image processing device 30 performs timing determination processing of determining a display timing of the map image.

Here, the timing determination processing will be described with reference to FIG. 23.

In step S301, the image processing device 30 determines whether the imaging device 1 is recording a captured image (a captured moving image). When the imaging device 1 is recording the captured image, the image processing device 30 turns the determination flag on in step S302 and ends the processing of FIG. 23.

Conversely, when the imaging device 1 is not recording the captured image, the image processing device 30 causes the processing to proceed from step S301 to step S303, turns the determination flag off when the determination flag is turned on, and end the processing of FIG. 23.

Referring back to FIG. 22, in step S108, the image processing device 30 determines whether the determination flag is turned on. When the determination flag is turned off, in step S109, the image processing device 30 displays only the captured image without superimposing and displaying the map image on the captured image. Conversely, when the determination flag is turned on in step S108, the image processing device 30 causes the processing to proceed to step S130.

When a first image is output in step S130, the image processing device 30 causes the processing to proceed to step S109 to control display of only the captured image. Thus, when the output first image is received, only the captured image can be displayed in, for example, an external display device connected to the imaging device 1.

When a second image different from the first image is output, the processing proceeds to an order of steps S108, S130, S131, and S110. In step S110, the map image is superimposed and displayed on the captured image.

Thus, the map image can be checked on, for example, the display unit of the imaging device 1 that receives the output second image.

The image processing device 30 returns the processing to step S101 after step S109 or S110 to perform the following similar processing.

Through the foregoing processing, the display control of the map image by the image processing device 30 according to the third embodiment is realized.

For example, when a movie is captured or the like, superimposition display of the map image on the captured image is useful for a person who performs focusing to perform the imaging with the imaging device 1 to adjust the focus or diaphragm mechanism. On the other hand, however, the map image may rather hinder a director or the like who checks the captured image on an external monitor connected to the imaging device 1 to check the captured image.

Accordingly, in the example of the third embodiment, by outputting a plurality of images with different content, it is possible to perform display control different for each output device.

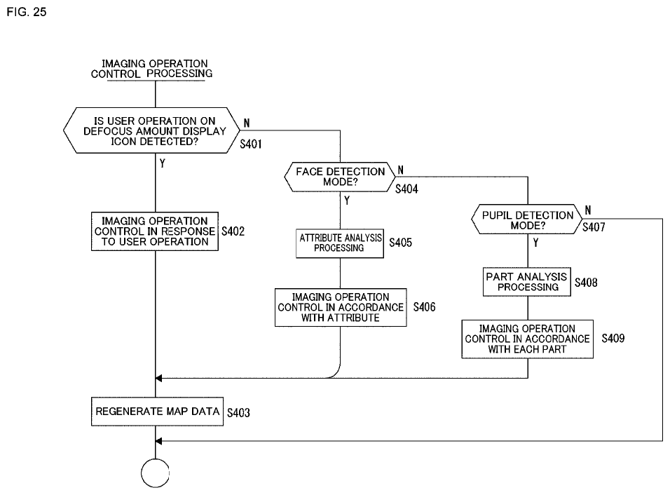

A fourth embodiment of the present technology will be described with reference to FIGS. 24 and 25.

The fourth embodiment relates to processing performed by the image processing device 30 that realizes imaging operation control of the captured image using the map data.

In FIG. 24, when the shutter operation performed by the user is not detected in step S101, the image processing device 30 causes the processing to proceed to step S102 to acquire the frame information from the imaging element unit 12. In step S103, the image processing device 30 performs the target region setting processing of FIG. 19 to set the target region in the captured image.

The image processing device 30 determines the generation map classification in step S104 and generates the map data in accordance with the determined map classification in step S105.

Thereafter, in step S140, the image processing device 30 performs imaging operation control processing.

Here, the details of the target region setting processing will be described with reference to FIG. 25.

The image processing device 30 determines whether a user operation on the defocus amount display icon is detected in step S401, whether the mode is a face detection mode in step S404, and whether the mode is the pupil detection mode in step S405 in order.

When the processing does not correspond to any of steps S401, S404, and S407, the image processing device 30 ends the processing of FIG. 25 without performing the imaging operation control.

When a user operation on the defocus amount display icon indicating a defocus amount of a target region is detected in step S401, the image processing device 30 causes the processing to proceed to step S402 to perform the imaging operation control in response to a user operation.

The user operation on the defocus amount display icon is a pinch-in or pinch-out operation of changing the diameter of the circular icon BC in FIG. 14A, for example. The user operation is an operation of vertically sliding the arrow DF provided in the defocus meter 62 in FIG. 14B.

The image processing device 30 controls an operation of the focus lens or the diaphragm mechanism in accordance with an operation amount of the foregoing user operation. Thus, it is possible to adjust a shift amount (a defocus amount) from a focus position of the target region.

When the imaging operation control ends, the image processing device 30 calculates the defocus amount again using the phase difference information or the imaging signal acquired from the position of the focus lens or the state of the diaphragm mechanism after the operation and generates the defocus map data in step S403. The image processing device 30 generates the defocus map image from the generated defocus map data and generates the depth map data from the defocus map data and the lens information. Then, the image processing device 30 ends the processing of FIG. 25.

When the mode is the face detection mode in step S404, the image processing device 30 causes the processing to step S405 to perform attribute analysis processing on the face region detected from the captured image through the image analysis processing. In the attribute analysis processing, the image processing device 30 acquires attribute information of the detected face region.

The attribute information is assumed to be various kinds of information such as information regarding attributes associated with the target region itself, such as an area of the target region, a ratio of the captured image occupied by the target region, and a position of the target region in the captured image; and attributes associated with the subject in the target region, such as the position of the subject, the number of people, an age, a gender, and the size of a face region.

In step S406, the image processing device 30 acquires fixed-value information of the defocus amount set in accordance with the attribute information.

The fixed value may be a value preset in accordance with the attribute information of the target region or a value of each position may be set by the user. The fixed value may be a numerical value of the defocus amount at each position of the target region or may be a correction ratio of the defocus amount at each position of the target region.

The image processing device 30 acquires the defocus amount information at a plurality of positions of the target region in accordance with the defocus map data and performs operation control of the focus lens or the diaphragm mechanism of the lens system 11 such that the fixed value of the defocus amount at each position set in the target region is obtained.

Thus, the shift amount (the defocus amount) from the focus position of the target region is adjusted. For example, by increasing the absolute value of the defocus amount of the face region in accordance with a gender or an age, it is possible to blur and display wrinkles of the face, as illustrated in FIG. 13.

When the imaging operation control ends, the image processing device 30 generates the defocus map data or the depth map data again using the phase difference information or the imaging signal acquired from the position of the focus lens or the state of the diaphragm mechanism after the operation in step S403 and ends the processing of FIG. 25.

When the mode is the pupil detection mode in step S407, the image processing device 30 causes the processing to step S408 to perform part analysis processing on the pupil region detected from the captured image through the image analysis processing. The image processing device 30 detects, for example, an eyelash region through the part analysis processing.

In step S409, the image processing device 30 performs operation control of the focus lens or the diaphragm mechanism in accordance with the detected part. The image processing device 30 acquires the fixed-value information of the defocus amount at each position of the target region associated with each part of the pupil region, for example, the eyelash region, and performs operation control of the diaphragm mechanism such that the fixed value of the defocus amount at each position set in the target region is obtained. The image processing device 30 may perform focus lens control of the lens system 11.

For example, each part of the target region is set in accordance with an attribute of the target region such as an eyelash part and the other part in the case of the pupil region or an eye part, a noise part, an ear part, a mouth part, or the like in the case of the face region.

When the imaging operation control ends, in step S403, the image processing device 30 generates the defocus map data or the depth map data again using the phase difference information or the imaging signal acquired from the position of the focus lens or the state of the diaphragm mechanism after the operation and ends the processing of FIG. 25.

Referring back to FIG. 24, in step S106, the image processing device 30 generates the map image using the map data generated again in step S403 of FIG. 25.

The image processing device 30 performs the timing determination processing of determining the display timing of the map image in step S107, as described above, for example, turns the determination flag on when the timing is the display timing, and turns the determination flag off when the timing is not the display timing.

In step S108, the image processing device 30 determines whether the determination flag is turned on. When the determination flag is turned off, in step S109, the image processing device 30 displays only the captured image without superimposing and displaying the map image on the captured image.

Conversely, when the determination flag is turned on in step S108, the image processing device 30 causes the processing to proceed to step S110 to superimpose and display the map image on the captured image.

When the processing of step S109 or S110 ends, the image processing device 30 returns the processing to step S101 to check detection of the shutter operation. When the shutter operation is detected in step S101, the image processing device 30 causes the processing to proceed to step S111 to acquire the frame information such as the imaging signal or the phase difference signal. The image processing device 30 acquires the map data when there is the generated map data.

In step S112, the image processing device 30 performs processing of recording the acquired frame information and map data. After the processing of step S112, the image processing device 30 returns the processing to step S101 to perform the foregoing processing.

Through the foregoing processing, the image processing device 30 according to the fourth embodiment realizes the imaging operation control of the captured image using the map data.

By performing the processing of steps S401 and S402 of FIG. 25 and changing the diameter of the circle icon of the icon group in any region selected by the user as in FIGS. 15 and 16, it is possible to adjust the defocus amount.

By performing the processing of steps S404, S405, and S406, the defocus amount in the face region is automatically adjusted as illustrated in FIG. 12. Further, by performing the processing of steps S407, S408, and S409, the defocus amount of the eyelash part in the pupil region is automatically adjusted as illustrated in FIG. 13.

### 5. Conclusion and Modification Examples

According to an embodiment, the image processing device 30 mounted on the imaging device 1 includes: the map data generation unit 31 configured to generate defocus map data which is calculated from phase difference information detected by image surface phase difference pixels in the imaging element unit 12 and indicates defocus amounts at a plurality of positions of a captured image by an imaging element unit 12; and the operation control unit 34 configured to perform imaging operation control using the defocus map data generated by the map data generation unit 31 (see FIG. 24).

Thus, the imaging operation control is performed based on the defocus amount information at the plurality of positions of the captured image.

Accordingly, it is possible to perform the imaging operation control such as the focus control and the operation control of the diaphragm operation in consideration of the distribution of the defocus amounts in a surface region such as a plurality of positions of the captured image rather than point positions such as focus positions.

The image processing device 30 according to the embodiment includes the display control unit 32 configured to generate a defocus map image indicating the distribution of the defocus amounts in the captured image using the defocus map data generated by the map data generation unit 31 and perform display control (see S110 of FIG. 24).

Thus, the distribution of the defocus amounts at the plurality of positions of the captured image is displayed as the defocus map image.

Accordingly, the user can check the distribution of the defocus amounts in the surface region such as the plurality of positions of the captured image after the imaging operation control is performed. Therefore, the user can determine whether it is necessary to perform the imaging operation control such as new focus control and operation control of the diaphragm mechanism in consideration of the distribution of the defocus amounts in the captured image (the target region).

The image processing device 30 according to the embodiment includes the target region setting unit 33 configured to set the target region in accordance with captured image content. The target region setting unit 33 sets a region in a captured image designated through a user operation as the target region (see S103 of FIG. 24).

Thus, the defocus map image is displayed in the target region in accordance with the captured image content.

Accordingly, by performing the imaging operation control on the target region selected by the user using the defocus map data, it is possible to adjust the defocus amount in the target region in which the purpose of the user is reflected.

The image processing device 30 according to the embodiment includes the target region setting unit 33 configured to set the target region in accordance with the captured image content. The map data generation unit 31 generates the defocus map data at a plurality of positions in the target region (see FIGS. 10 and 11).

Thus, data of each of the defocus amounts at the plurality of positions in the target region is calculated. By automatically setting the target region in accordance with the captured image content such as attribute information of the subject and performing the imaging operation control in the target region, it is possible to adjust the defocus amount in which the captured image content such as the attribute information of the subject is reflected.

In the image processing device 30 according to the embodiment, the operation control unit 34 performs the imaging operation control using the defocus map data in the target region generated by the map data generation unit 31 (see S402, S406, and S409 of FIG. 25).

Thus, the imaging operation control is performed based on the defocus amount information at the plurality of positions in the target region. Accordingly, by selecting the target region in accordance with an imaging purpose and performing the imaging operation control on the selected target region using the defocus map data, it is possible to adjust the defocus amount obtained by narrowing down points in which the imaging purpose is reflected.

In the image processing device 30 according to the embodiment, the operation control unit 34 performs the imaging operation control such that the defocus amount of the target region is a preset fixed value with reference to the defocus map data (see S402, S406, and S409 of FIG. 25).

For example, in the imaging device, the operation control of the focus lens or the operation control of the diaphragm mechanism is performed so that the defocus amounts at the plurality of positions in the target region are preset fixed values. Thus, by setting the value of each defocus amount as a fixed value in accordance with the attribute information or the like of the subject (the target region) such as an age and a gender, it is possible to perform display in a state in which gradation appropriate for the subject (the target region) is put. Accordingly, it is possible to automatically adjust the appropriate defocus amount in accordance with the attribution information or the like of the subject (the target region).

In the image processing device 30 according to the embodiment, the operation control unit 34 performs imaging operation control such that the defocus amount of the target region is a fixed value set through a user operation with reference to the defocus map data (see S402, S406, and S409 of FIG. 25).

For example, in the imaging device, the operation control of the focus lens or the operation control of the diaphragm mechanism is performed so that the defocus amounts at the plurality of positions in the target region are fixed values set through a user operation.

By allowing the user to be able to set the defocus amount in the target region as the fixed value, it is possible to set the adjustment amount of the defocus amount suitable for the attribute of the subject (the target region) in accordance with preference of the user. Accordingly, through the imaging operation control, it is possible to adjust the defocus amount in which an intention of the user is further reflected.

In the image processing device 30 according to the embodiment, the operation control unit 34 performs imaging operation control using the defocus map data in accordance with the attribute information of the target region (see S406 and S409 of FIG. 25).

Thus, the defocus amounts at the plurality of positions in the target region are corrected in accordance with the attribute information. Accordingly, it is possible to automatically adjust the appropriate defocus amount in accordance with the attribution information or the like of the subject (the target region).

In the image processing device 30 according to the embodiment, the attribute information is an attribute associated with the target region (see S406 and S409 of FIG. 25).

Thus, for example, it is possible to perform the imaging operation control in accordance with an area of the target region, a ratio of the captured image by occupied the target region, a position of the target region in the captured image, or the like.

In the image processing device 30 according to the embodiment, the attribute information is an attribute associated with a subject in the target region (see S406 and S409 of FIG. 25).

Thus, for example, it is possible to perform the imaging operation control in accordance with the position of the subject, the number of people, an age, a gender, the size of a face region, or the like.

In the image processing device 30 according to the embodiment, the imaging operation control is focus control (S402, S406, and S409 of FIG. 25). The focus control is performed, for example, by controlling the operation of the focus lens of the imaging device. For example, by shifting the focus position from the subject (a captured region), it is possible to adjust the defocus amount (a blurring state) of the subject (the captured region).

In the image processing device 30 according to the embodiment, the imaging operation control is control for changing the depth of field (S409 of FIG. 25). The control for changing the depth of field is performed, for example, by controlling an operation of the diaphragm mechanism of the imaging device.

In the image processing device 30 according to the embodiment, the display control unit 32 generates a defocus map image painted in a color in accordance with the defocus amount at each position of the captured image (see FIGS. 10 and 11).

Thus, the difference in the value of the defocus amount of each position of the captured image is displayed as a difference in color in the defocus map image. Accordingly, by displaying a difference in the value of the defocus amount of each position of the captured image (the target region) in color, it can be easy to ascertain the distribution amount in the captured image (the target region) visually and intuitively.

When the defocus amount of a certain position in the captured image (the target region) is changed, by checking the change in the color of the position, it can be easy to visually recognize whether the image is changed toward the focus position or whether the focus position is changed in before blurring or after blurring otherwise. Accordingly, based on the display of the color, it can be easy to adjust the blurring of the subject on an imaging screen intuitively.

In the image processing device 30 according to the embodiment, the operation control unit 34 performs imaging operation control in response to a user operation on a defocus map image (see S402 of FIG. 25).

Thus, the defocus amount of each position of the captured image is changed by adjusting the focus position in the captured image in response to the user operation. Accordingly, it is possible to adjust the defocus amount in which an intention of the user is reflected.

In the image processing device 30 according to the embodiment, the display control unit 32 generates a defocus map image using a defocus amount display icon in which a display mode is different in accordance with the defocus amount. The operation control unit 34 performs imaging operation control in response to a user operation on the defocus amount display icon in the defocus map image (see S402 of FIG. 25).

Thus, imaging operation control is performed in accordance with the change in the display mode of the defocus amount display icon in response to the user operation and the defocus amount of the position corresponding to the defocus amount display icon is changed in accordance with the imaging operation control.

Since a change in the defocus amount of each position of the captured image (the target region) can be checked with a change in the display mode of the defocus amount display icon, it can be easy to ascertain the defocus amount of the captured image (the target region) changed through a user operation visually and intuitively.

In the image processing device 30 according to the embodiment, the target region setting unit 33 sets a face region detected through face detection in the captured image as the target region (S208 of FIG. 19).

Thus, the focus position in the face region in the captured image is adjusted. When a wrinkle, a spot, or the like in the face region is relatively conspicuous, the face region can be blurred by slightly shifting the focus position in the face region. In this way, by setting the face region detected through the face detection as the target region, for example, it is possible to adjust the defocus amount in accordance with an age, a gender, or the like.

In the image processing device 30 according to the embodiment, the target region setting unit 33 sets a pupil region detected through pupil detection in the captured image as the target region (see S211 of FIG. 19).

Thus, the focus position in the pupil region of the captured image is adjusted. For example, it is possible to perform the imaging operation control on each part, such as the operation control of the diaphragm mechanism, in an eyelash part of the pupil region.

A program according to the embodiment is a program causing, for example, a CPU, a DSP, or the like or a device including this to perform the processing of FIGS. 18 to 25.

That is, the program according to the embodiment is a program causing an image processing device to perform: a map data generation function of generating defocus map data which is calculated from phase difference information detected by a phase difference detection unit and indicates defocus amounts at a plurality of positions of a captured image by an imaging element unit; and an operation control function of performing imaging operation control using the defocus map data generated by the map data generation function. The program can realize the above-described image processing device 30 in a device such as the portable terminal 2, the personal computer 3, or the imaging device 1, for example.

The program can be recorded in advance in an HDD serving as a recording medium embedded in a device such as a computer device or a ROM or the like in a microcomputer that includes a CPU.

Alternatively, the program can be stored (recorded) temporarily or perpetually on a removable recording medium such as a flexible disc, a compact disc read-only memory (CD-ROM), a magnet optical (MO) disc, a digital versatile disc (DVD), a Blu-ray Disc (registered trademark), a magnetic disk, a semiconductor memory, or a memory card. The removable recording medium can be provided as so-called package software.

The program can be installed from the removable recording medium to a personal computer and can also be downloaded from a download site via a network such as a local area network (LAN) or the Internet.

Such a program is appropriate for broad provision of the imaging processing device according to the embodiment. For example, by downloading the program to a personal computer, a portable information processing device, a mobile phone, a game device, a video device, a personal digital assistant (PDA), or the like, it is possible to cause the personal computer or the like to function as the image processing device according to the present disclosure.

The advantageous effects described in the present specification are merely exemplary and are not limitative, and other advantageous effects can be achieved.

The present technology can be configured as follows.

(1)

An image processing device including:

a map data generation unit configured to generate defocus map data which is calculated from phase difference information detected by a phase difference detection unit and indicates defocus amounts at a plurality of positions of a captured image by an imaging element unit; and

an operation control unit configured to perform imaging operation control using the defocus map data generated by the map data generation unit.

(2)

The information processing device according to (1), wherein the phase difference detection unit detects the phase difference information with an image surface phase difference pixel in the imaging element unit.

(3)

The image processing device according to (1) or (2), further including:

a display control unit configured to generate a defocus map image indicating a distribution of defocus amounts in the captured image using the defocus map data generated by the map data generation unit and perform display control.

(4)

The image processing device according to any one of (1) to (3), further including:

a target region setting unit configured to set a target region in accordance with captured image content,

wherein the target region setting unit sets a region in a captured image designated through a user operation as the target region.

(5)

The image processing device according to any one of (1) to (4), further including:

a target region setting unit configured to set a target region in accordance with captured image content,

wherein the map data generation unit generates the defocus map data at a plurality of positions in the target region.

(6)

The image processing device according to (4) or (5), wherein the operation control unit performs imaging operation control using the defocus map data in the target region generated by the map data generation unit.

(7)

The image processing device according to (6), wherein the operation control unit performs imaging operation control such that a defocus amount of the target region is a preset fixed value with reference to the defocus map data.

(8)

The image processing device according to (6), wherein the operation control unit performs imaging operation control such that the defocus amount of the target region is a fixed value set through a user operation with reference to the defocus map data.

(9)

The image processing device according to any one of (6) to (8), wherein the operation control unit performs imaging operation control using the defocus map data in accordance with attribute information of the target region.

(10)

The image processing device according to (9), wherein the attribute information is an attribute associated with the target region.

(11)

The image processing device according to (9) or (10), wherein the attribute information is an attribute associated with a subject in the target region.

(12)

The image processing device according to any one of (1) to (11), wherein the imaging operation control is focus control.

(13)

The image processing device according to any one of (1) to (12), wherein the imaging operation control is control for causing a change in a depth of field.

(14)

The image processing device according to any one of (3) to (13), wherein the display control unit generates a defocus map image in a color in accordance with the defocus amount at each position of the captured image.

(15)

The image processing device according to any one of (1) to (14), wherein the operation control unit performs imaging operation control in response to a user operation on a defocus map image.

(16)

The image processing device according to any one of (3) to (15), wherein the display control unit generates a defocus map image using a defocus amount display icon in which a display mode is different in accordance with the defocus amount; and

wherein the operation control unit performs imaging operation control in response to a user operation on the defocus amount display icon in the defocus map image.

(17)

The image processing device according to any one of (4) to (16), wherein the target region setting unit sets a face region detected through face detection in the captured image as the target region.

(18)

The image processing device according to any one of (4) to (16), wherein the target region setting unit sets a pupil region detected through pupil detection in the captured image as the target region.

(19)

An image processing method including:

generating defocus map data which is calculated from phase difference information detected by a phase difference detection unit and indicates defocus amounts at a plurality of positions of a captured image by an imaging element unit; and

performing imaging operation control using the generated defocus map data.

(20)

A program causing an image processing device to perform:

a map data generation function of generating defocus map data which is calculated from phase difference information detected by a phase difference detection unit and indicates defocus amounts at a plurality of positions of a captured image by an imaging element unit; and

an operation control function of performing imaging operation control using the defocus map data generated by the map data generation function.

(21)

An imaging device including:

an imaging element unit configured to perform imaging;

a map data generation unit configured to generate defocus map data which is calculated from phase difference information detected by a phase difference detection unit and indicates defocus amounts at a plurality of positions of a captured image by the imaging element unit; and

an operation control unit configured to perform imaging operation control using the defocus map data generated by the map data generation unit.

### REFERENCE SIGNS LIST

1 Imaging device

12 Imaging element unit

22 Phase difference detection unit

30 Image processing device

31 Map data generation unit

32 Display control unit

33 Target region setting unit

34 Operation control unit

35 Recording control unit

1. An image processing device comprising:
a map data generation unit configured to generate defocus map data which is calculated from phase difference information detected by a phase difference detection unit and indicates defocus amounts at a plurality of positions of a captured image by an imaging element unit; and
an operation control unit configured to perform imaging operation control using the defocus map data generated by the map data generation unit.

2. The image processing device according to claim 1, wherein the phase difference detection unit detects the phase difference information with an image surface phase difference pixel in the imaging element unit.

3. The image processing device according to claim 1, further comprising:
a display control unit configured to generate a defocus map image indicating a distribution of defocus amounts in the captured image using the defocus map data generated by the map data generation unit and perform display control.

4. The image processing device according to claim 1, further comprising:
a target region setting unit configured to set a target region in accordance with captured image content,
wherein the target region setting unit sets a region in a captured image designated through a user operation as the target region.

5. The image processing device according to claim 1, further comprising:
a target region setting unit configured to set a target region in accordance with captured image content,
wherein the map data generation unit generates the defocus map data at a plurality of positions in the target region.

6. The image processing device according to claim 5, wherein the operation control unit performs imaging operation control using the defocus map data in the target region generated by the map data generation unit.

7. The image processing device according to claim 6, wherein the operation control unit performs imaging operation control such that a defocus amount of the target region is a preset fixed value with reference to the defocus map data.

8. The image processing device according to claim 6, wherein the operation control unit performs imaging operation control such that the defocus amount of the target region is a fixed value set through a user operation with reference to the defocus map data.

9. The image processing device according to claim 6, wherein the operation control unit performs imaging operation control using the defocus map data in accordance with attribute information of the target region.

10. The image processing device according to claim 9, wherein the attribute information is an attribute associated with the target region.

11. The image processing device according to claim 9, wherein the attribute information is an attribute associated with a subject in the target region.

12. The image processing device according to claim 1, wherein the imaging operation control is focus control.

13. The image processing device according to claim 3, wherein the display control unit generates a defocus map image in a color in accordance with the defocus amount at each position of the captured image.

14. The image processing device according to claim 1, wherein the operation control unit performs imaging operation control in response to a user operation on a defocus map image.

15. The image processing device according to claim 3,
wherein the display control unit generates a defocus map image using a defocus amount display icon in which a display mode is different in accordance with the defocus amount; and
wherein the operation control unit performs imaging operation control in response to a user operation on the defocus amount display icon in the defocus map image.

16. The image processing device according to claim 4, wherein the target region setting unit sets a face region detected through face detection in the captured image as the target region.

17. The image processing device according to claim 4, wherein the target region setting unit sets a pupil region detected through pupil detection in the captured image as the target region.

18. An image processing method comprising:
generating defocus map data which is calculated from phase difference information detected by a phase difference detection unit and indicates defocus amounts at a plurality of positions of a captured image by an imaging element unit; and
performing imaging operation control using the generated defocus map data.

19. A program causing an image processing device to perform:
a map data generation function of generating defocus map data which is calculated from phase difference information detected by a phase difference detection unit and indicates defocus amounts at a plurality of positions of a captured image by an imaging element unit; and
an operation control function of performing imaging operation control using the defocus map data generated by the map data generation function.

20. An imaging device comprising:
an imaging element unit configured to perform imaging;
a map data generation unit configured to generate defocus map data which is calculated from phase difference information detected by a phase difference detection unit and indicates defocus amounts at a plurality of positions of a captured image by the imaging element unit; and
an operation control unit configured to perform imaging operation control using the defocus map data generated by the map data generation unit.
